(19) United States
(12) Patent Application Publication
(10) Pub. No.: US 2026/0310937 A1
(43) Pub. Date: Oct. 8, 2026

(54) PERSISTENT MEMORY-BASED ARCHITECTURE FOR AVATAR-BASED APPLICATIONS USING BRIEFING DATA STRUCTURES

(71) Applicant: Citibank, N.A., New York, NY (US)

(72) Inventors: James Randolph MYERS, Clearwater Beach, FL (US); Jefferson OKRAKU, New York, NY (US); Dipendra Malhotra, Cranbury, NJ (US); Aravind Pitchai Guruswamy, Readington Township, NJ (US); Satchel AVIRAM, Brooklyn, NY (US); Karolina BELWAL, Weehawken, NJ (US); Tarak MEHTA, West Windsor, NJ (US); Ranjit Kumar ANGIYA RAMESHBABU, Chennai (IN); Robin JAIN, Pune (IN); Vasanthakumar Rajendran, Bridgewater, NJ (US); Deepak KELA, Pittsboro, NC (US); Rachit KUMAR, Fair Lawn, NJ (US); Joseph V. Bonanno, JR., Scarsdale, NY (US); Prasanth Babu MADAKASIRA RAMAKRISHNA, New York, NY (US); Girish WALI, New York, NY (US); Deepali TUTEJA, New York, NY (US); Ernst Wilhelm SPANNHAKE, II, Canal Winchester, OH (US); Thomas Francis GIANELLE, Colleyville, TX (US); Milan SHAH, Plano, TX (US)

(21) Appl. No.: 19/699,873

(22) Filed: Jun. 5, 2026

Related U.S. Application Data
(63) Continuation-in-part of application No. 19/632,237, filed on Mar. 28, 2026.
Application No. 19/632,237 is a continuation-in-part of application No. 19/442,927, filed on Jan. 7, 2026.
(63) Continuation-in-part of application No. 18/826,086, filed on Sep. 5, 2024.
Application No. 18/826,086 is a continuation of application No. 18/418,201, filed on Jan. 19, 2024, now Pat. No. 12,165,035.
Application No. 18/418,201 is a continuation-in-part of application No. 18/354,569, filed on Jul. 18, 2023, now Pat. No. 12,164,525.
Application No. 18/354,569 is a continuation-in-part of application No. 18/174,498, filed on Feb. 24, 2023, now Pat. No. 11,868,860.
Application No. 18/174,498 is a continuation-in-part of application No. 18/065,441, filed on Dec. 13, 2022, now Pat. No. 11,704,540.

(51) Int. Cl. G06N 3/045; G06N 3/088

(52) U.S. Cl. CPC G06N 3/045; G06N 3/088

(57) ABSTRACT

The systems and methods disclosed herein relate to a persistent memory-based architecture for avatar-based applications that maintains user-specific data across multiple interaction sessions. A briefing data that includes interaction data between a user and an artificial intelligence agent and/or user time-series data is accessed from a persistent memory. In response to receiving additional interaction data, portions of the additional interaction data are linked to the briefing data structure. A user-specific input is constructed by combining the briefing data structure, the portions of the additional interaction data, a predicted state output and/or a dataset retrieved from one or more data repositories. The user-specific output is transmitted to input layers of the artificial intelligence agent to generate a user-specific output. The briefing data structure is updated to include a representation of the user-specific output.

### CROSS-REFERENCE TO RELATED APPLICATION(S)

This application is a continuation-in-part of U.S. patent application Ser. No. 19/632,237, entitled “PERSISTENT RELATIONAL MEMORY ARCHITECTURES FOR DIALOGUE PROCESSING BY AVATAR-BASED SYSTEMS,” filed Mar. 28, 2026, which is a continuation in part of U.S. patent application Ser. No. 19/442,927, entitled “MULTI-SOURCE MEMORY SYNCHRONIZATION FOR AVATAR-BASED CONVERSATIONAL INTERFACES,” filed on Jan. 7, 2026.

This application is further a continuation-in-part of U.S. patent application Ser. No. 18/826,086, entitled “SYSTEMS AND METHODS FOR RESPONDING TO PREDICTED EVENTS IN TIME-SERIES DATA USING SYNTHETIC PROFILES CREATED BY ARTIFICIAL INTELLIGENCE MODELS TRAINED ON NON-HOMOGENEOUS TIME-SERIES DATA,” filed Sep. 5, 2024, which is a continuation of U.S. patent application Ser. No. 18/418,201, entitled “SYSTEMS AND METHODS FOR RESPONDING TO PREDICTED EVENTS IN TIME-SERIES DATA USING SYNTHETIC PROFILES CREATED BY ARTIFICIAL INTELLIGENCE MODELS TRAINED ON NON-HOMOGENEOUS TIME-SERIES DATA,” filed Jan. 19, 2024, which is a continuation-in-part of U.S. patent application Ser. No. 18/354,569, entitled “SYSTEMS AND METHODS FOR AGGREGATING TIME-SERIES DATA STREAMS BASED ON POTENTIAL STATE CHARACTERISTICS FOLLOWING AGGREGATION,” filed Jul. 18, 2023, which is a continuation-in-part of U.S. patent application Ser. No. 18/174,498, entitled “SYSTEMS AND METHODS FOR COHORT-BASED PREDICTIONS IN CLUSTERED TIME-SERIES DATA IN ORDER TO DETECT SIGNIFICANT RATE-OF-CHANGE EVENTS,” filed Feb. 24, 2023, which is a continuation-in-part of U.S. patent application Ser. No. 18/065,441, entitled “SYSTEMS AND METHODS FOR RESPONDING TO PREDICTED EVENTS IN TIME-SERIES DATA USING SYNTHETIC PROFILES CREATED BY ARTIFICIAL INTELLIGENCE MODELS TRAINED ON NON-HOMOGONOUS TIME SERIES-DATA,” filed Dec. 13, 2022.

This application is further related to U.S. patent application Ser. No. 18/327,850, entitled “SYSTEMS AND METHODS FOR RESPONDING TO PREDICTED EVENTS IN TIME-SERIES DATA USING SYNTHETIC PROFILES CREATED BY ARTIFICIAL INTELLIGENCE MODELS TRAINED ON NON-HOMOGENOUS TIME SERIES-DATA,” filed Jun. 1, 2023, which is a continuation of U.S. patent application Ser. No. 18/065,441, entitled “SYSTEMS AND METHODS FOR RESPONDING TO PREDICTED EVENTS IN TIME-SERIES DATA USING SYNTHETIC PROFILES CREATED BY ARTIFICIAL INTELLIGENCE MODELS TRAINED ON NON-HOMOGONOUS TIME SERIES-DATA,” filed Dec. 13, 2022.

This application is further a continuation-in-part of U.S. patent application Ser. No. 19/660,162, entitled “SYSTEMS AND METHODS FOR MAINTAINING SEQUENTIAL RELATIONSHIPS IN AGGREGATED TIME-SERIES DATA STREAMS USING TIME SHIFTED EVENT TRIGGERS,” filed Apr. 27, 2026, which is a continuation of U.S. patent application Ser. No. 18/975,914, entitled “SYSTEMS AND METHODS FOR MAINTAINING SEQUENTIAL RELATIONSHIPS IN AGGREGATING TIME-SERIES DATA STREAMS USING TIME SHIFTED EVENT TRIGGERS,” filed Dec. 10, 2024, which is a continuation-in-part of U.S. patent application Ser. No. 18/354,569, entitled “SYSTEMS AND METHODS FOR AGGREGATING TIME-SERIES DATA STREAMS BASED ON POTENTIAL STATE CHARACTERISTICS FOLLOWING AGGREGATION,” filed Jul. 18, 2023, which is a continuation-in-part of U.S. patent application Ser. No. 18/174,498, entitled “SYSTEMS AND METHODS FOR COHORT-BASED PREDICTIONS IN CLUSTERED TIME-SERIES DATA IN ORDER TO DETECT SIGNIFICANT RATE-OF-CHANGE EVENTS,” filed Feb. 24, 2023, which is a continuation-in-part of U.S. patent application Ser. No. 18/065,441, entitled “SYSTEMS AND METHODS FOR RESPONDING TO PREDICTED EVENTS IN TIME-SERIES DATA USING SYNTHETIC PROFILES CREATED BY ARTIFICIAL INTELLIGENCE MODELS TRAINED ON NON-HOMOGENOUS TIME SERIES-DATA,” filed Dec. 13, 2022. The content of each of the foregoing applications is incorporated herein in its entirety by reference.

### BACKGROUND

An avatar, such as a digital avatar, refers to a digital representation that presents information to a user (i.e., any entity such as a human user, an automated system, an AI system) through text, audio, visual outputs, or combinations thereof. The avatar can be implemented as a text-based interface that renders responses as displayed character strings, a voice-based interface that synthesizes speech from generated text and outputs audio signals via speakers, a visual interface that renders an animated graphical representation on a display device, and so forth. In some implementations, the avatar presents as a two-dimensional or three-dimensional animated figure that exhibits facial expressions, lip movements synchronized with synthesized speech, and body gestures that correspond to the content being communicated. In other implementations, the avatar presents as a static image paired with text or audio output, or as a purely auditory presence without visual representation.

The avatar can operate as a user-facing component of the AI agent by translating the outputs generated by underlying AI models into a format perceivable by the user. The AI agent includes one or more AI models that process input data and generate output data, such as language models, classification models, decision models, and so forth. The AI agent and the avatar can execute on the same computing device, such as a local processor, or can execute on separate computing devices connected via a network, such as a cloud-based AI agent that transmits output data to a client device running the avatar rendering logic. However, conventional AI agent architectures typically operate in a stateless manner, processing each user input independently without retaining information from prior interaction sessions. Thus, the corresponding AI agent typically treats each interaction as an isolated event and oftentimes requires the user to re-establish context and/or restate preferences across sessions.

### BRIEF DESCRIPTION OF THE DRAWINGS

FIG. 1A illustrates exemplary data types included in a briefing data structure, in accordance with some implementations of the present technology.

FIG. 1B shows an illustrative user interface including briefing data, in accordance with some implementations of the present technology.

FIG. 2 illustrates a display for showing peer asset changes in accordance with some implementations of the present technology.

FIG. 3 shows a schematic illustrating an example environment of deploying an artificial intelligence (AI) avatar with a persistent relational memory architecture, in accordance with some implementations of the present technology.

FIG. 4 shows a schematic illustrating an example environment of a persistent data structure implemented by an avatar interaction platform, in accordance with some implementations of the present technology.

FIG. 5 is a flow diagram illustrating an example process of implementing a persistent relational memory architecture using an avatar interaction platform, in accordance with some implementations of the present technology.

FIG. 6 shows a schematic illustrating an example environment of deploying an AI avatar using an avatar interaction platform, in accordance with some implementations of the present technology.

FIG. 7 shows a schematic illustrating an example environment of an architecture implemented by an avatar interaction platform to synchronize memory from multiple sources, in accordance with some implementations of the present technology.

FIG. 8 shows an illustration of an example environment of a latent space used by an avatar interaction platform to synchronize memory from multiple sources, in accordance with some implementations of the present technology.

FIG. 9 illustrates a layered architecture of an AI system that can implement the machine learning (ML) models of an avatar interaction platform, in accordance with some implementations of the present technology.

FIG. 10 is a block diagram showing some of the components typically incorporated in at least some of the computer systems and other devices on which the avatar interaction platform operates, in accordance with some implementations of the present technology.

FIG. 11 is a system diagram illustrating an example of a computing environment in which the avatar interaction platform operates, in accordance with some implementations of the present technology.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

An interface between a human and a computational system refers to a mechanism that enables bidirectional exchange of information between a user (i.e., any entity such as a human user, an automated system, an AI system) and computing resources. The interface receives input from the user in various modalities such as text entered through a keyboard, speech captured through a microphone, or gestures detected through cameras or sensors. The input is converted into data representations that the computational system can use to execute programmatic instructions and perform operations such as retrieving stored information, performing calculations, or generating new data based on the input. The computational system produces output data that is subsequently presented to the user.

Conversational agents refer to a type of interface that enables users to interact with computational resources through natural language exchanges. For example, some conventional conversational agents operate through rule-based systems that match user inputs against predefined patterns and return scripted responses associated with those patterns. Other conventional conversational agents use statistical models that identify associations between inputs and responses from training data (rather than relying on manually authored rules). Further, some conventional conversational agents use neural network architectures that process input text through multiple layers of transformations to generate responses token by token, rather than selecting from predefined templates. These neural network-based agents can generate responses that were not present in training data by identifying patterns of language structure and semantic relationships during training on text corpora.

Avatars refer to a type of interface that evolved from conversational agents by incorporating a representational identity that persists across interactions and presents information through one or more output modalities. An avatar can manifest as a text-based persona, a voice-based persona that delivers speech, and/or a visual persona. In some implementations, the avatar combines multiple modalities by presenting as a two-dimensional or three-dimensional animated figure that exhibits body gestures that correspond to the content being communicated. In some implementations, the avatar presents as a static visual representation or no visual representation. The avatar operates as a point of interaction through which users submit inputs and receive outputs.

Conventional avatar systems typically operate using stateless architectures in which each interaction session is processed independently of other sessions. A stateless architecture does not maintain persistent data structures that link information across temporally distributed sessions, and instead treats each session as a self-contained unit that begins without prior context and ends without preserving context for future sessions. When a conventional avatar receives a user input, the conventional avatar processes the input using only the information available within the current session, such as the immediately preceding exchanges in the ongoing dialogue. This architectural limitation constrains the responsiveness and personalization capabilities of conventional avatars.

Thus, conventional avatar systems typically require users to re-establish context each time they interact through a different channel or device. For example, when a user initiates a conversation with a conventional avatar through a mobile application and subsequently attempts to continue the conversation through a web browser or wearable device, the conventional avatar lacks awareness of the prior interaction because the conversational state is stored locally on the original device and/or on a server through a channel accessible only by the original device. The user thus must repeat information that was previously provided, re-explain preferences that were previously expressed, and so forth. This repetition consumes time and creates friction in the user experience. The problem is compounded when users frequently switch between devices based on situational convenience. Each transition requires the user to invest effort in reconstructing the conversational context that was lost during the channel switch.

Conventional avatar systems that do maintain a form of memory of prior interactions (e.g., short-term memory, long-term memory) typically treat all stored memories with equal importance regardless of when the interactions occurred, with whom the interactions occurred, and/or how relevant they remain to the user's current circumstances. When a conventional avatar retrieves context from its memory to inform a response, the avatar may surface information from interactions that occurred months or years ago alongside information from recent interactions. However, a preference expressed by the user during an interaction two years ago may no longer reflect the user's current preferences. The user's circumstances change over time as events occur and priorities shift, but the conventional avatar's memory fails to account for this temporal dimension of relevance. Some conventional systems do incorporate rudimentary decay mechanisms that erase older conversations or exclude them from consideration after a fixed time period, but these approaches continue to remain inadequate because the conventional approaches apply uniform decay policies regardless of the content or importance of the stored information. For example, a conventional system that deletes all interactions older than six months, may result in the loss of contextual information that remains relevant to the user's ongoing needs. Additionally, conventional decay mechanisms typically operate as binary decisions that either include or exclude entire conversations, and fail to account for different aspects of stored information based on their continued relevance to the user's evolving circumstances. Thus, conventional avatars often generate responses that are disconnected from the user's current reality.

Further, avatars deployed as external systems or services face limitations in accessing information maintained within internal enterprise infrastructure. When an avatar operates on computing resources external to an organization's network perimeter, the avatar lacks direct connectivity to internal databases and/or other backend systems that store user-specific information. External systems attempting to query internal databases typically encounter access restrictions because the firewalls block connection requests originating from outside the network perimeter to prevent unauthorized access to sensitive data. Without access to internal information, the avatar is unable to retrieve data used to generate responsive and/or personalized responses. Thus, the avatar is limited to providing generic information that does not require access to user-specific records, which reduces the utility of the avatar for tasks that require knowledge of individual user circumstances.

In the alternative, hosting avatars on internal computing infrastructure (as opposed to external computing infrastructures) presents resource allocation challenges due to the computational demands of generating avatar responses and rendering audiovisual outputs. Avatars that generate responses through neural network-based models typically require substantial processing power to perform the operations used to generate the output(s). Neural network-based models typically use millions of parameters, which consume significant processor cycles and memory bandwidth. Further, generating synchronized audiovisual outputs requires additional computational resources beyond those used to generate text-based outputs. Internal computing infrastructure typically operates with a fixed capacity, and the variable demand for avatar services creates inefficiencies in resource utilization because the infrastructure would be provisioned to handle peak usage periods and leave resources underutilized during periods of lower demand.

Avatars deployed in regulated fields such as healthcare or financial services encounter constraints when operating across infrastructure boundaries due to the sensitive nature of the information used to generate responses. Regulated fields are subject to legal and regulatory frameworks (e.g., guidelines, constraints) that impose requirements on how certain types of information must be stored, transmitted, and processed to protect confidentiality and prevent unauthorized disclosure. For example, in healthcare contexts, information such as medical diagnoses, treatment histories, and prescription records constitutes protected health information that is subject to regulations governing its transmission. In another example, in financial services contexts, information such as account balances, transaction details, and investment holdings constitutes confidential financial data that is subject to regulations governing its use. When an avatar requests access to such information to generate personalized and/or responsive responses, the transmission of that information from internal systems where it is stored to external systems where response generation occurs creates potential exposure of sensitive data across infrastructure boundaries. However, regulatory frameworks often require that sensitive information remain within controlled environments (and/or specific geographies) that implement specific security measures (e.g., encryption, access logging, audit trails). Since external systems may not implement the same security controls as internal systems, compliance risks are created when sensitive information is transmitted to those external systems for processing.

Conventional avatar systems typically operate using sequential processing architectures, which typically introduces latency issues that degrade user experience. When conventional avatar systems route user queries through multiple layers (e.g., security checkpoints, validation layers, data retrieval operations), each processing stage adds delay to the total response time. In conversational interactions, users expect responses within timeframes that approximate natural human dialogue, and delays exceeding several seconds disrupt the conversational flow and reduce user engagement. The latency issues become more pronounced when conventional avatar systems operate across geographically distributed infrastructure where network transmission times between data centers in different regions introduce additional delays.

As such, the inventor(s) have developed systems (hereinafter “avatar interaction platform”) and related methods for accessing persistent memory structures that maintain user-specific information across multiple interaction sessions with an artificial intelligence (AI) agent (e.g., via a digital avatar). An avatar interaction platform can capture dialogue data (or other user inputs, agent outputs, and/or behavioral signals) between a user and an AI agent across one or more interaction sessions and extract structured attribute data (i.e., quantified representations of user intent, preferences, and decision-making characteristics) from the captured dialogue data. The structured attribute data can be maintained in a persistent data structure (e.g., a knowledge graph, a vector database, a relational schema) that defines relationships linking the attribute data across the plurality of interaction sessions. The persistent data structure can be accessible to the avatar interaction platform (e.g., via an avatar interface host). The avatar interaction platform can query the persistent data structure to access a briefing data structure (e.g., a knowledge graph, a vector database, a relational schema, or any other data structure) that represents (e.g., aggregates, maps, condenses) the structured attribute data.

In response to receiving additional interaction data from an input (e.g., a new user input, an external trigger, a scheduled event), the avatar interaction platform links (e.g., maps, connects, associates) parts of the additional interaction data to the briefing data structure (i.e., identifies, within the additional interaction data, requests for data represented in the briefing data structure). The avatar interaction platform constructs a user-specific input by combining the briefing data structure, the additional interaction data (or parts of the additional interaction data), a predicted state output that is generated using an AI model and data from the briefing data structure, and/or a dataset or multiple datasets from a repository. The repository can be internal (e.g., retrieved from within perimeters of a network associated with the avatar) or external (e.g., retrieved from outside perimeters of a network associated with the avatar).

The user-specific input is transmitted to input layers (e.g., data reception layers) of the artificial intelligence agent. The artificial intelligence agent generates a user specific output that is responsive to (i.e., generated based on or generated using) the user-specific input. The avatar interaction platform updates the briefing data structure to include a representation of the user-specific output. The updated briefing data structure can be stored in the persistent memory data structure. The avatar interaction platform addresses the above-mentioned technical challenges by accessing data stored in a persistent data structure that enables querying and retrieval of user-specific information across interaction sessions.

Rather than storing raw dialogue transcripts that require substantial storage resources and computational overhead to search, the avatar interaction platform accesses stored structured attribute data that quantifies user intent in a format that can be used for retrieval and comparison operations. The persistent data structure defines relationships between attribute data entries that enable traversal-based queries, which reduces the computational complexity of identifying relevant historical context compared to searching unstructured text. The avatar interaction platform can further reduce latency by generating vector embeddings of the structured attribute data that enable similarity-based retrieval in an embedding space, rather than requiring sequential comparison against all stored records. The persistent memory can be implemented using solid-state storage devices that provide non-volatile retention of the briefing data structure across power cycles, enabling the avatar interaction platform to resume interaction sessions with full access to historical context without requiring re-computation of stored attribute data. The vector index data structures used for similarity-based retrieval can be optimized for execution on graphics processing units (GPUs) that perform parallel distance calculations across multiple vector embeddings simultaneously, thereby reducing retrieval latency compared to sequential processing on central processing units (CPUs). The avatar interaction platform achieves storage improvements by accessing extracted structured attribute data from dialogue data rather than retaining complete dialogue transcripts.

In some implementations, the structured attribute data occupies less storage space than the corresponding raw dialogue data because the extraction process identifies and retains relevant information while discarding redundant or otherwise irrelevant content. The avatar interaction platform achieves retrieval improvements by accessing extracted structured attribute data in persistent data structures. For example, when the persistent data structure is implemented as a knowledge graph, the avatar interaction platform can retrieve attribute data by traversing edges from nodes corresponding to the input event rather than scanning all stored records. When the persistent data structure includes vector embeddings, the avatar interaction platform can retrieve relevant attribute data by identifying the top-k most similar embeddings through distance calculations in embedding space.

In some implementations, the avatar interaction platform achieves latency improvements by pre-computing relationships between attribute data entries during storage operations, such that retrieval operations can traverse pre-established relationships rather than computing relationships at query time. In some implementations, the traversal-based queries enabled by the knowledge graph structure reduce query complexity from O(n) to O(log n) or O(1) for indexed lookups, where n represents the number of stored records. The vector embedding approach enables approximate nearest neighbor searches that identify relevant records in sub-linear time relative to the total number of stored embeddings, thereby maintaining responsive interaction latencies even as the volume of historical interaction data grows over successive sessions.

The disclosed avatar interaction platform is further enabled to deploy artificial intelligence (AI) avatars that generate audio and video responses to user interactions across various infrastructure environments. In response to an interaction request, the avatar interaction platform establishes a connection between a client application and a first infrastructure layer and invokes (e.g., concurrently, selectively) multiple agents trained on domain-specific knowledge bases to retrieve associated data records (e.g., user information). A domain-specific knowledge base refers to a structured collection of information organized around a particular subject area (e.g., client profiles, transaction histories, product specifications, service records). Each agent specializes in retrieving information from a specific domain by executing queries against backend databases or application programming interfaces (APIs) that provide access to that domain's data.

The retrieved data and/or additional user input are routed to a second infrastructure layer hosting a generative AI model that uses the routed data to generate an avatar response structured as audio and/or video signals. In some implementations, the first infrastructure layer operates within an internal network perimeter controlled by an enterprise entity (e.g., an institution) that maintains security controls over sensitive user data. In some implementations, the second infrastructure layer operates within an external cloud environment (e.g., provided by a third-party service provider) that provides computational resources for executing generative AI models. The generated avatar response can be transmitted back to the client application (e.g., via the first and second infrastructure layers) for presentation.

The avatar interaction platform addresses the above-mentioned technical challenges by implementing a hybrid architecture that separates data retrieval operations from response generation operations across distinct infrastructure layers. By positioning the agents within the internal infrastructure layer, the avatar interaction platform enables direct access to sensitive data repositories without creating security vulnerabilities. Thus, the retrieved data records can be redacted before transmitting the data to a second infrastructure layer that hosts generative AI models. Further, by separating the data retrieval operations that require access to internal systems from the computationally intensive response generation operations that benefit from cloud-scale resources, the avatar interaction platform enables avatars to generate personalized responses based on user-specific information without requiring the entity controlling the first (e.g., internal) infrastructure layer to provision internal infrastructure for peak demand scenarios.

The disclosed avatar interaction platform is further enabled to access memory from multiple sources for avatar-based outputs. The avatar interaction platform can access a plurality of memory data structures that include a first memory data structure representing records generated by the AI avatar during prior communication sessions with a user (e.g., historical user inputs and avatar responses from previous conversations, in some examples stored as a briefing data structured that aggregates or represents observed interaction data), a second memory data structure representing records stored outside of the persistent memory structure (e.g., generated predicted state outputs or data structures received from internal or external repositories), and/or a third memory data structure representing session context data captured during the current communication session (e.g., user inputs and avatar responses and state information generated since the session was initiated). The avatar interaction platform aggregates the memory data structures into a unified memory representation by, for example, generating a vector embedding for each record (i.e., a numerical encoding that captures the semantic meaning of the record) and indexing the vector embeddings into a common vector space (i.e., a multi-dimensional space in which semantically similar records are positioned near each other).

Unlike conventional decay mechanisms that apply uniform temporal policies, the briefing data structure enables content-aware relevance determination by maintaining structured relationships between attribute data entries. The knowledge graph structure enables the system to preserve older information that remains relevant to current user goals while deprioritizing more recent information that pertains to superseded preferences. For example, a user goal established two years ago that remains active can be weighted more heavily than a transient preference expressed last week that the user has since contradicted through subsequent interactions.

The avatar interaction platform can apply one or more weighting operations to portions of the unified memory representation to generate a prioritized memory representation, where the weighting operations assign weight values based on attributes such as timestamps associated with each portion, such that more recent records receive higher weight values relative to older records (e.g., through a temporal decay function that reduces weight values as elapsed time increases). The avatar interaction platform can generate an avatar response using a generative AI model. The avatar response can include an audio signal (e.g., synthesized speech conveying the response content) and/or a video signal (e.g., animated visual representations of the AI avatar synchronized to the audio signal, sign language gestures, and so forth). The memory data structures can be stored in a distributed database accessible across multiple interaction channels (e.g., a mobile application interface, a web-based interface, a wearable device interface), thereby enabling the avatar interaction platform to maintain conversational continuity when a user transitions between channels during or between communication sessions.

In some implementations, the avatar interaction platform addresses the above-mentioned technical challenges by storing memory data structures in a distributed database accessible across multiple interaction channels rather than storing conversational state locally on individual devices or on servers accessible only through specific channels. When a user transitions from one interaction channel to another (e.g., from a mobile application to a web browser to a wearable device), the avatar interaction platform can retrieve the memory data structures from the distributed database through the new channel and use the retrieved memory to continue the conversation with awareness of prior interactions. The distributed storage architecture ensures that conversational context is preserved regardless of which device or interface the user uses, thereby eliminating or otherwise reducing the need for users to repeat information or re-establish context when switching between channels. The avatar interaction platform further addresses the technical challenge of inaccessible external interaction history by aggregating records from external sources into the same unified memory representation. The AI avatar can thus reference information from external engagements as prior interaction experience, which enables the avatar to generate responses that account for the user's full relationship history with an organization and/or entity rather than treating each interaction as if no prior relationship exists.

In some implementations, the AI models described throughout the description herein operate as neurosymbolic AI systems that integrate neural network processing with symbolic reasoning. A neurosymbolic AI system represents a computational architecture that combines neural networks with symbolic reasoning systems to perform both statistical pattern recognition and logical inference operations. The neurosymbolic AI systems can maintain neural network components that perform statistical pattern recognition (e.g., using learned parameter weights) and symbolic reasoning components that execute rule-based inference (e.g., using logic operations). The neural component includes, for example, interconnected nodes with learned parameter weights that evaluate input data to identify patterns and extract feature representations using one or more transformations. The symbolic component operates using one or more logic systems, knowledge graphs, and/or rule-based engines that execute logical operations using defined relationships and/or constraints. In some implementations, the neural network inference results operate as inputs to the symbolic reasoning system, and the symbolic reasoning system is enabled to execute one or more evaluations against the defined relationships and/or constraints to verify that generated neural network inference results comply with the defined relationships and/or constraints.

When implemented as neurosymbolic AI system(s), the AI models can maintain separate neural and symbolic components that evaluate user input data and generate validated outputs. The neural component, for example, processes the user input data through multiple layers of interconnected nodes to generate provisional responses based on statistical patterns learned during training. The provisional responses represent candidate outputs that satisfy a confidence threshold value based on the training data but have not yet been validated against logical constraints. The symbolic component receives the provisional responses from the neural component and evaluates them against a set of predefined rules and constraints encoded in a database, such as a knowledge graph or rule-based system. The knowledge graph can define relationships between entities (e.g., user goals and associated constraints, behavioral characteristics and dependent preferences) and constraints that must be satisfied (e.g., user-specified boundaries, prior stated preferences). When a provisional response violates a constraint (e.g., generating an output that contradicts a previously expressed user preference), the symbolic component rejects the response and can request the neural component to generate an alternative response and/or modify the response.

While the avatar interaction platform is described in detail with one or more sequences of operations, the order in which these operations are performed can be modified or rearranged. For example, the avatar interaction platform accesses the briefing data structure and then maps portions of the additional interaction data to the briefing data structure. In some implementations, the avatar interaction platform receives additional interaction data, then accesses the briefing data structure, then maps the portions of the additional interaction data to the briefing data structure. In some implementations, the avatar interaction platform can perform one or more operations in parallel rather than sequentially by spawning multiple execution threads that operate concurrently to reduce total processing time. The specific ordering of operations described in the detailed description and illustrated in the figures represents example implementation sequences, but alternative orderings are additionally within the scope of the disclosed technology.

Further, while the avatar interaction platform is described in detail for deploying avatars that maintain persistent memory across interaction sessions using briefing data structures, the avatar interaction platform can be applied, with appropriate modifications, to deliver services across diverse application domains. For example, the avatar interaction platform can be deployed in customer service contexts where users interact with avatars to resolve product issues, track orders, and/or obtain technical support, and where the persistent memory architecture enables the avatar to recall prior support interactions and user preferences. In another example, the avatar interaction platform can be deployed in educational contexts where users interact with avatars to receive instruction, and where the persistent memory architecture enables the avatar to track learning progress and adapt content delivery based on historical interaction patterns. The examples provided in this paragraph are intended as illustrative and are not limiting. Any other applications or workflows referenced in this document, and many others unmentioned, are equally appropriate after appropriate modifications.

While the current description provides examples related to knowledge graphs, vector embeddings, and relational schemas as persistent data structures, one of skill in the art would understand that the disclosed techniques can apply to other forms of data storage and retrieval architectures. For example, the disclosed avatar interaction platform can retrieve structured attribute data using document databases, graph databases, time-series databases, key-value stores, and/or other suitable data storage systems. Similarly, while the current description provides examples related to similarity thresholds and vector-based retrieval for identifying correspondences between input events and stored attribute data, the disclosed techniques can apply to other retrieval mechanisms including keyword-based indexing, semantic search, hybrid retrieval approaches that combine multiple retrieval methods, and the like.

In some implementations, the avatar interaction platform can address multiple technical limitations of conventional avatar systems through a unified persistent memory-based architecture. Conventional avatar systems that operate using stateless architectures process each interaction session independently without retaining information from prior sessions, which can require users to re-establish context and restate preferences across sessions. The avatar interaction platform can overcome this limitation by maintaining a briefing data structure in a persistent memory that aggregates interaction data and user time-series data across multiple interaction sessions, such that the artificial intelligence agent can access cumulative user history when generating responses. The avatar interaction platform can further address context continuity limitations by storing memory data structures in a distributed database accessible across multiple interaction channels, enabling the avatar to retrieve prior interaction context regardless of which device or interface the user employs. The avatar interaction platform can address data access limitations by implementing a hybrid architecture that separates data retrieval operations within an internal infrastructure layer from response generation operations within an external infrastructure layer, enabling direct access to sensitive data repositories through internal agents while leveraging external computational resources for generative AI model execution.

In some implementations, the persistent memory can be implemented using any of several data storage architectures, including a knowledge graph that represents user-specific information as interconnected nodes and edges, a vector database that stores user-specific information as numerical vectors in a high-dimensional embedding space where semantically similar information occupies nearby positions, a relational database that organizes user-specific information into tables with defined schemas where relationships between entries are established through foreign key references, or a hybrid structure that combines two or more of the foregoing architectures.

Further, while the current description provides examples related to neurosymbolic AI models, generative AI models, large language models (LLMs), and agents, one of skill in the art would understand that the disclosed techniques can apply to other forms of machine learning or AI algorithms/models, including unsupervised, semi-supervised, supervised, and reinforcement learning techniques. For example, the disclosed avatar interaction platform can generate outputs using model outputs from symbolic AI models, support vector machine (SVM), k-nearest neighbor (KNN), decision-making, linear regression, random forest, naïve Bayes, or logistic regression algorithms, and/or other suitable computational models.

The avatar interface through which the artificial intelligence agent communicates with the user can be implemented in various modalities, including a text-based interface, a voice-based interface that synthesizes speech, a visual interface that renders an animated two-dimensional or three-dimensional graphical representation synchronized with synthesized speech, or a multimodal interface that combines two or more of the foregoing modalities. The avatar interaction platform can operate across various infrastructure configurations, including a local configuration in which the artificial intelligence agent and the persistent memory execute on a single computing device, a cloud configuration in which the artificial intelligence agent executes on cloud-hosted computing resources, or a distributed configuration in which data retrieval operations execute on internal infrastructure while response generation operations execute on external infrastructure.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean that the specific feature, structure, or characteristic following the phrase is included in at least one implementation of the present technology and can be included in more than one implementation. In addition, such phrases do not necessarily refer to the same implementations or different implementations.

### Example Persistent Memory Architectures Used by the Avatar Interaction Platform

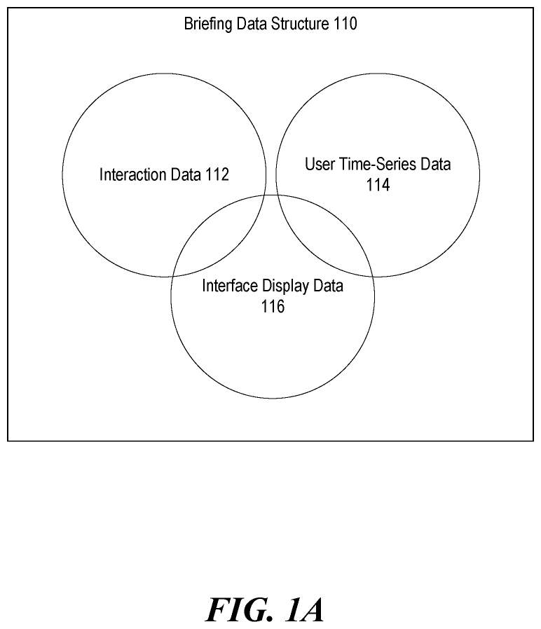

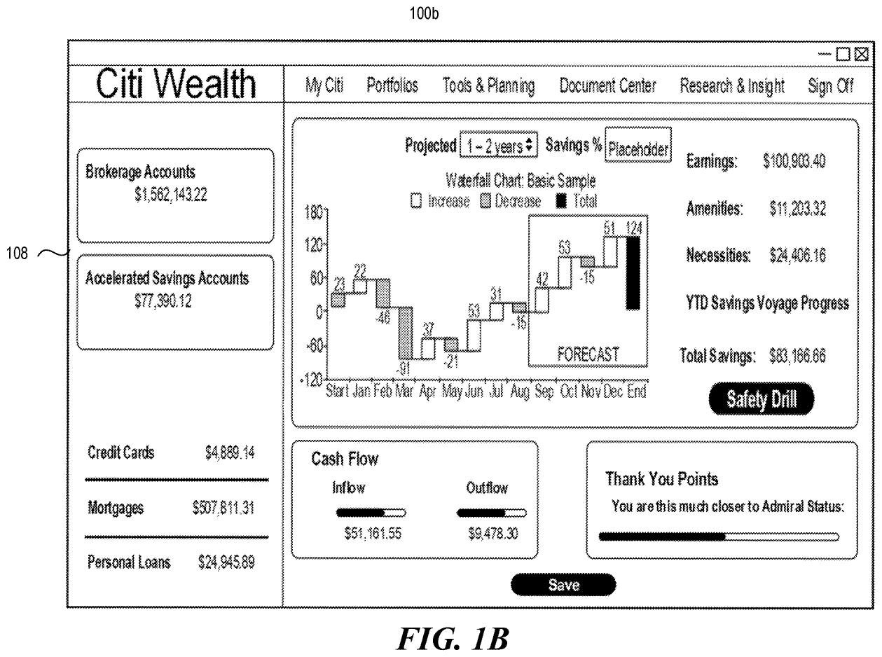

FIG. 1A illustrates exemplary data types included in a briefing data structure 110, in accordance with some implementations of the present technology. The briefing data structure 110 is a low-latency comprehensive data structure that can be stored in advance in the persistent memory and activated when the avatar interface is initiated. The briefing data structure 110 can aggregate user-specific information that enables the artificial intelligence agent to generate contextually relevant responses without requiring real-time (or near-real-time) retrieval or generation of all underlying data at the time of each interaction. The briefing data structure 110 can include data components such as interaction data 112, user time-series data 114, and interface display data 116. In some implementations, portions of the interaction data 112, the user time-series data 114, and the interface display data 116 share common elements and can be combined to generate unified representations for use by the artificial intelligence agent. The briefing data structure 110 can be stored in a persistent data structure such as a knowledge graph, a vector database, a relational schema, or any other data structure, and can be updated as new interaction sessions occur and as new data (e.g., time-series data) becomes available.

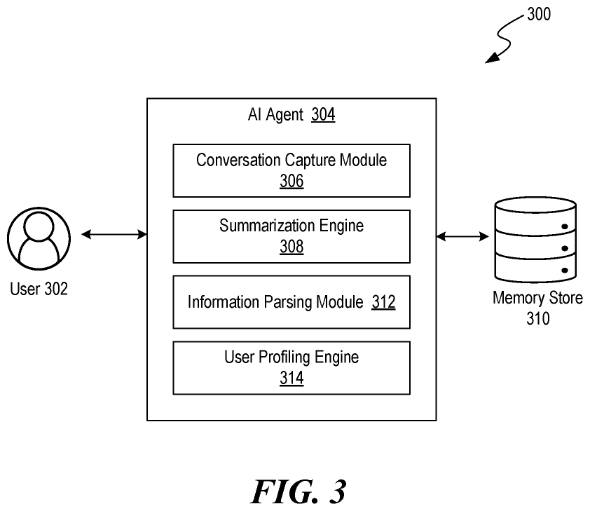

Interaction data 112 represents data captured from dialogues and exchanges between the user and the artificial intelligence agent across multiple interaction sessions. The interaction data 112 can include user inputs such as transcribed speech, typed text, captured images, and/or logged user actions such as button clicks or menu selections, as well as agent responses generated during those sessions. The interaction data 112 includes one or more behavioral signals associated with the user, where each behavioral signal refers to an observable indicator of user intent or user state extracted from the dialogue data. For example, a behavioral signal can represent an explicit statement of preference made by the user, such as a declared goal or a stated constraint. In another example, a behavioral signal can represent an implicit indicator inferred from user behavior, such as a repeated inquiry about a particular topic indicating sustained interest, a pattern of short responses indicating a preference for brevity, or a delay in response time indicating hesitation or uncertainty. The interaction data 112 can be processed by a summarization engine (such as summarization engine 308 described with respect to FIG. 3) that parses the recorded dialogues to identify explicit statements made by the user, such as stated goals, expressed constraints, or declared preferences, and that identifies patterns in the interaction data 112 to infer implicit information, such as recurring topics that indicate sustained interest, response latencies that indicate engagement levels, and sentiment shifts that indicate changing attitudes. The summarization engine can output structured attribute data that represents the extracted information in a format configured for storage and retrieval, such as key-value pairs, labeled data fields, or graph nodes with associated properties. In some implementations, the interaction data 112 can include the extracted information output by the summarization engine.

User time-series data 114 represents temporal sequences of user-related information that capture characteristics of the user as they change over time. The user time-series data 114 can include a sequence of data points that occur in successive order over some period of time, where each data point is associated with a corresponding timestamp. The user time-series data 114 can be taken on any variable that changes over time and that is relevant to the user's profile or circumstances. For example, in some implementations, the user time-series data 114 can include financial data such as account balances, portfolio values, transaction histories, or rates of return tracked over time. In such implementations, the user time-series data 114 can represent current state characteristics such as current holdings, positions, or investment strategies, as well as required future state characteristics such as a target rate of return or a target account value. In other implementations, the user time-series data 114 can include health metrics, activity levels, engagement frequencies, usage patterns, or other measurable attributes that vary over time. The user time-series data 114 can be used to identify patterns, trends, and predicted states by analyzing the temporal sequences for secular trends describing movement along a term, seasonal variations representing periodic changes, cyclical fluctuations corresponding to periodical but not seasonal variations, or irregular variations representing other nonrandom sources of variation.

In some implementations, the user time-series data 114 can include data that is not organized as a temporal sequence. For example, the user time-series data 114 can include cross-sectional data that captures a snapshot of one or more user characteristics at a single point in time, such as a current asset allocation distribution, or a current set of demographic attributes. The cross-sectional data can be processed by the system to generate derived metrics, such as computing a ratio between two cross-sectional values, determining a percentile ranking of a user characteristic relative to a population of users, or classifying the user into a category based on threshold comparisons applied to the cross-sectional values. In some implementations, the user time-series data 114 can include categorical data that represents discrete attributes of the user, such as preference labels assigned by the user or inferred by the system. The categorical data can be processed by encoding the categorical values into numerical representations, such as one-hot encodings or ordinal encodings, that enable the artificial intelligence agent to incorporate the categorical data into computational operations alongside numerical data. In some implementations, the user time-series data 114 can include unstructured data such as text annotations, notes from prior consultations, or free-form user inputs that do not conform to a predefined schema. The unstructured data can be processed by applying natural language processing techniques to extract structured attributes, such as topic labels, sentiment scores, or entity references, that can be stored in the briefing data structure 110 and used by the artificial intelligence agent to generate contextually relevant responses.

Interface display data 116 represents information that is prepared for presentation to the user on an interface, such as a user interface rendered by the avatar application on a client device. The interface display data 116 can include information derived from the interaction data 112 and/or the user time-series data 114. For example, the interface display data 116 can include representations such as charts, graphs, summaries, tables, numbers, text, or visual indicators that describe trends or patterns identified in the user time-series data 114. The interface display data 116 can include textual summaries or notifications generated based on behavioral signals extracted from the interaction data 112. In some implementations, the interface display data 116 includes recommendations generated by an artificial intelligence model that processes the interaction data 112 and the user time-series data 114 to identify context-relevant, time-based observations. In some examples, he relevance of an observation can be measured based on factors such as temporal proximity to the current interaction, frequency of related user inquiries across prior sessions, alignment with explicitly stated user goals stored in the briefing data structure 110, or similarity scores computed between the observation and the user's current context using vector-based comparison operations. In some implementations, relevance can be defined by a weighted combination of these factors, where the weights are adjusted based on the user's historical engagement patterns or domain-specific heuristics that prioritize certain types of observations over others.

For example, the artificial intelligence model can analyze the user time-series data 114 to detect rate-of-change events or predicted states and generate recommendations for responding to those events, such as recommending to maintain a current trajectory or recommending a modification to a current state characteristic. For another example, the artificial intelligence model can recommend a specific action the user might want to take based on patterns observed in the interaction data 112. For instance, the artificial intelligence model can analyze the interaction data 112 to identify that the user has repeatedly inquired about a particular topic over multiple sessions, such as retirement planning options, and can generate a recommendation to schedule a consultation or review related educational materials. The artificial intelligence model can further predict questions the user is likely to ask based on the current context of the interaction combined with historical patterns, such as predicting that a user who has just reviewed a portfolio performance summary will next inquire about rebalancing options based on similar sequences observed in prior sessions.

In some implementations, the interface display data 116 includes indications of a synthetic profile generated for the user. The synthetic profile can include current state characteristics associated with an entity cluster (e.g., a demographic, a financial peer group) into which the user has been classified by a machine learning model. The interface display data 116 can include indications of the synthetic profile, a combination of variables associated with recommended items, the current state characteristics of the user, or a new entity variable associated with the current state characteristics of the user. For example, the interface display data 116 can include a first set of future state variables for items associated with the current state characteristics of the user and a second set of future state variables for items associated with the entity cluster, enabling the user to compare current performance against recommended alternatives. The interface display data 116 can further include interactive elements that allow the user to enter data, save data, or select from presented options, thereby enabling exchange of information between the user and the artificial intelligence agent through the interface.

FIG. 1B shows an illustrative user interface 100b including briefing data, in accordance with some implementations of the present technology. As referred to herein, a “user interface” may include a human-computer interaction and communication in a device, and may include display screens, keyboards, a mouse, and the appearance of a desktop. For example, a user interface may include a way a user interacts with an application or a website. In some implementations, the user interface may display content related to or included in the briefing data structure.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user. In some implementations, content may be displayed on the user interface.

In some implementations, the content may include a client portal that provides recommendations based on one or more models. For example, the client portal may identify context relevant time-based observations and share these observations as recommendations with the client. The recommendations may provide a line of sight to the areas that clients may want to consider but were not aware they should be considering in an intermediate timeframe. For example, the clients have numerous options for planning major life events and the avatar interaction platform (e.g., via user interface 100b) may act as a conduit to allow client have control of the intermediate term and expose them to one or more features.

In some implementations, the content may include awards that are achievable within certain timeframes to incent behavior in line with the client's unique objectives. For example, by establishing a “status” level with various aspirational levels, the avatar interaction platform may incentivize a client to increase use of the avatar interaction platform. The avatar interaction platform may also provide one or more recommendations that are interactive. These interactive recommendations may allow a user to enter data or save data.

In some implementations, the content may include data components from the briefing data structure 110 illustrated in FIG. 1A. For example, the content may include the interaction data 112 representing dialogues and exchanges between the user and the artificial intelligence agent, the user time-series data 114 representing temporal sequences of user-related information such as account balances or portfolio values, and/or the interface display data 116 representing information prepared for presentation to the user such as charts, graphs, summaries, or recommendations. The content may further include unified representations generated from the overlapping portions of the interaction data 112, the user time-series data 114, and the interface display data 116, enabling the avatar interaction platform to present contextually relevant information that combines historical interaction patterns with current state characteristics and predictive insights.

In some implementations, the avatar interaction platform may monitor content generated by the user to generate user profile data. As referred to herein, “a user profile” and/or “user profile data” may include data actively and/or passively collected about a user. For example, the user profile data may include content generated by the user and a user characteristic for the user. A user profile may be content consumed and/or created by a user.

User profile data may also include a user characteristic. As referred to herein, “a user characteristic” may include about a user and/or information included in a directory of stored user settings, preferences, and information for the user. For example, a user profile may have the settings for the user's installed programs and operating system. In some implementations, the user profile may be a visual display of personal data associated with a specific user, or a customized desktop environment. In some implementations, the user profile may be digital representation of a person's identity. The data in the user profile may be generated based on the avatar interaction platform actively or passively monitoring.

In some implementations, a user characteristic may include a current state characteristic. For example, the avatar interaction platform may receive current account information for a first user account (e.g., a “first system state”) of an automated family office system. The current account information may include current holdings, positions, investments, etc., which may represent a “current state characteristic” for the account. Additionally, the current account information may include investment strategies, rates of return, etc.

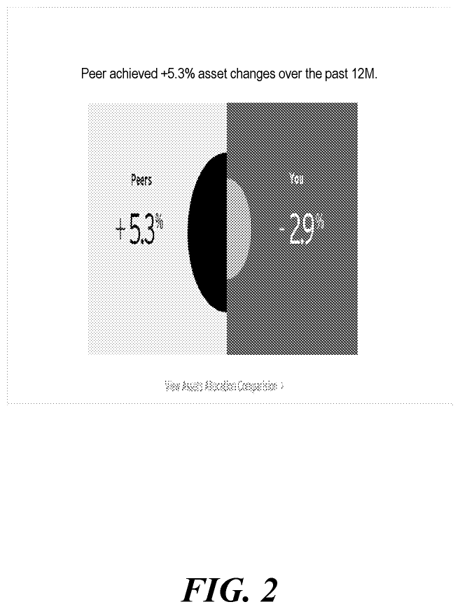

FIG. 2 illustrates a display for showing peer asset changes in accordance with some implementations of the present technology. The display presents a comparison between the performance of a user's current items and the performance of items associated with one or more peer entities identified as sharing similar characteristics with the user. For example, the avatar interaction platform can classify the user into an entity cluster of a plurality of entity clusters using a clustering machine learning model trained on current state characteristics such as demographic data, and can identify one or more peer entities associated with the entity cluster. The avatar interaction platform can generate, for the entity cluster, an item characteristic dataset based on items associated with the one or more peer entities, where the item characteristic dataset can include performance data such as return on investment data, risk data, or reward data. The avatar interaction platform can determine, based on the item characteristic dataset, a subset of items having a predetermined output variable, such as a return on investment value that exceeds a threshold or that ranks among the highest values within the entity cluster.

The avatar interaction platform can then provide to the user an indication of the predetermined output variable for the recommended items and an entity variable corresponding to the user's current set of items, enabling the user to compare the two values. For example, the display can present a first portion illustrating a return on investment for the user's peers and a second portion illustrating the user's current investment returns, such that the user can observe the difference between the peer group's performance and the user's performance over a given time period. In some implementations, the avatar interaction platform can generate a synthetic profile for the user that includes current state characteristics associated with the entity cluster, add the subset of recommended items and a combination of variables associated with those items to the synthetic profile, and generate for display indications of the synthetic profile alongside the user's current state characteristics.

The asset changes shown in FIG. 2 can be derived from data, for example data included in the briefing data structure 110 described with reference to FIG. 1A. For example, the user time-series data 114 within the briefing data structure 110 can include temporal sequences of user-related information such as portfolio values, individual asset returns, or account balances tracked over successive time periods, where each data point is associated with a corresponding timestamp. The avatar interaction platform can use the user time-series data 114 to determine the user's current state characteristics, such as current holdings and rates of return, and can compare those characteristics against the item characteristic dataset generated for the user's peer entity cluster.

In some implementations, the avatar interaction platform can receive first time-series data for one or more items associated with the current state characteristics of the user and second time-series data for the subset of items associated with the entity cluster, determine a first set of future state variables for the user's current items and a second set of future state variables for the recommended items, and generate for display one or more indications of the first set of future state variables and the second set of future state variables. The resulting comparison data, including the predetermined output variable, the entity variable, and any projected future state variables, can be included in the interface display data 116 as content to be displayed on a user interface such as the user interface 100b described with reference to FIG. 1B. For example, the interface display data 116 can include graphical representations depicting the difference between the user's portfolio returns and the peer group's portfolio returns over a twelve-month period, along with interactive elements that enable the user to access additional details such as an assets allocation comparison between the user's portfolio allocation and the peer group's portfolio allocation.

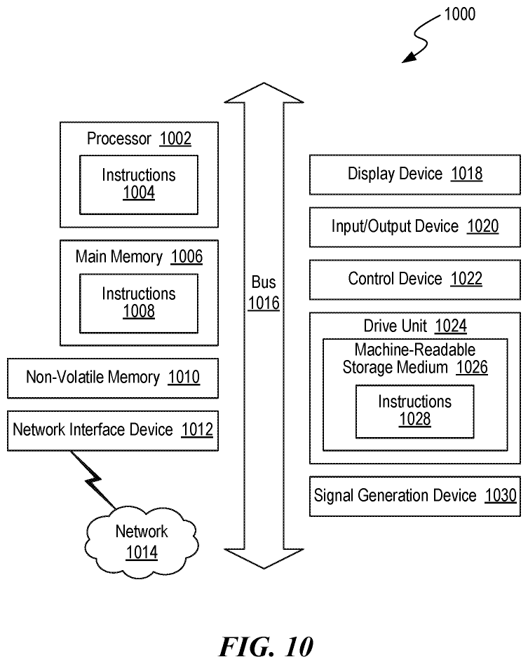

FIG. 3 shows a schematic illustrating an example environment 300 of deploying an artificial intelligence (AI) avatar with a persistent relational memory architecture, in accordance with some implementations of the present technology. The environment 300 can be implemented using components of example computer system 1000 illustrated and described in more detail with reference to FIG. 10. Likewise, implementations of example environment 300 can include different and/or additional components or can be connected in different ways.

A user 302 can refer to an entity enabled to generate input data, such as a human operator, an automated agent, an autonomous system, or another computational entity. An AI agent 304 refers to a computational system that processes input data and generates output data through machine learning models, natural language processing algorithms, rule-based inference engines, and so forth. The user 302 produces an input stream that includes data in one or more modalities such as audio signals captured via microphones, physical expressions captured via depth sensors or camera arrays that track facial movements and body gestures, images captured via cameras, text strings entered via keyboards or touchscreens, video frames captured via recording devices, or combinations thereof. The AI agent 304 produces an output stream that includes data in the form of synthesized audio signals rendered via speakers, physical expressions rendered via animated digital representations displayed on screens, generated images, text strings displayed via graphical interfaces, video frames rendered via display devices, or combinations thereof.

A conversation capture module 306 can obtain interaction data between the user 302 and the AI agent 304 by recording the input stream, the output stream, or both. The conversation capture module 306 can be implemented as a data logging service that timestamps and stores each exchange between the user 302 and the AI agent 304 in a sequential record. In some implementations, the conversation capture module 306 records multi-turn dialogues between the user 302 and the AI agent 304 across temporally distributed interaction sessions, where each session is associated with a session identifier and a timestamp range.

A summarization engine 308 within or accessible by the AI agent 304 can process the captured interaction data to extract structured information. The summarization engine 308 parses the recorded dialogues to identify explicit statements made by the user 302, such as stated goals, expressed constraints, or declared preferences. The summarization engine 308 identifies patterns in the interaction data to infer implicit information, such as recurring topics that indicate sustained interest, response latencies that indicate engagement levels, sentiment shifts that indicate changing attitudes, and so forth. The summarization engine 308 outputs structured attribute data that represents the extracted information in a format configured for storage and retrieval (e.g., key-value pairs, labeled data fields, graph nodes with associated properties).

In some implementations, the summarization engine 308 can store the extracted structured attribute data in a memory store 310. The memory store 310 maintains user-specific data structures that link related pieces of structured attribute data across multiple interaction sessions. For example, the memory store 310 can be implemented as a knowledge graph where nodes represent distinct concepts such as user goals, stated preferences, historical decisions, or interaction events, and edges represent relationships between the nodes such as causal links, temporal sequences, or hierarchical dependencies. In some implementations, the memory store 310 can be implemented as a vector database where each piece of structured attribute data is represented as a numerical vector, and relationships between data entries are determined by determining a distance or similarity measure between vectors. In some implementations, the memory store 310 can be implemented as a relational database where structured attribute data is organized into tables with defined schemas, and relationships are established through foreign key references between tables.

The AI agent 304 can include or otherwise access an information parsing module 312 that queries the memory store 310 to determine what information should be included in a user-specific input based on additional interaction data received from the user 302. When the AI agent 304 receives a new input from the user 302, the information parsing module 312 analyzes the content of the input and identifies relevant stored attribute data that corresponds to the input. The information parsing module 312 can retrieve any of the data included in the briefing data structure 110, including the data used to display user interface 100b, advice from internal resources such as a research database maintained by an internal (e.g., operating from or sitting within the network perimeter) team or other analyses such as the peer entity analysis depicted in FIG. 2, or advice from external (e.g., operating from or sitting outside the network perimeter) resources such as web searches. For example, if the user 302 mentions a topic discussed in a prior interaction session, the information parsing module 312 retrieves the stored attribute data associated with that topic and includes the retrieved data in the user-specific input for generating a contextually relevant output.

The information parsing module 312 can identify relevant information by comparing current input data against stored attribute data extracted by the summarization engine 308. When the user 302 provides a new input via the input stream, the information parsing module 312 extracts features from the input, such as keywords, topic identifiers, or semantic representations, and queries the memory store 310 to retrieve stored attribute data that shares similar features. The information parsing module 312 determines a relevance score for each retrieved attribute data entry by measuring the degree of correspondence between the input features and the stored features, such as by determining a cosine similarity between vector representations or by counting matching keywords weighted by historical frequency. If the relevance score exceeds a relevance criterion, the information parsing module 312 flags the correspondence as relevant to the current communication session and tags the corresponding data for inclusion in the user-specific input. In some implementations, the information parsing module 312 performs vector-based similarity searches by generating an embedding of the additional interaction data and identifying stored attribute data entries whose embeddings fall within a threshold distance in the embedding space. In other implementations, the information parsing module 312 performs keyword-based indexing by extracting terms from the additional interaction data and matching those terms against an inverted index of stored attribute data entries. In further implementations, the information parsing module 312 performs hybrid retrieval by combining vector similarity scores with keyword match scores to produce a composite relevance ranking.

The information parsing module 312 can filter retrieved information by comparing candidate data entries against stored attribute data representing prior stated preferences, which can be included for example in interaction data 112. Before the information parsing module 312 includes a data entry in the user-specific input, the information parsing module 312 retrieves stored attribute data from the memory store 310 that represents constraints, boundaries, or preferences previously expressed by the user 302. The information parsing module 312 evaluates each candidate data entry against each retrieved constraint by checking whether the data entry violates, contradicts, or is inconsistent with the stored preference. For example, if the user 302 previously stated a preference to avoid a particular category of content, and a candidate data entry includes content from that category, the information parsing module 312 identifies the contradiction. Upon detecting a conflict, the information parsing module 312 can exclude the candidate data entry from the user-specific input, preventing the conflicting information from influencing the generated output. Alternatively, the information parsing module 312 can modify the candidate data entry by removing the conflicting portion, substituting alternative content, or appending contextual information that acknowledges the deviation from the stored preference before including the modified entry in the user-specific input.

The information parsing module 312 can prioritize retrieved information by accessing stored attribute data representing historical interaction patterns. The memory store 310 maintains records of how the user 302 has interacted with the AI agent 304 over prior sessions, including attributes such as topics of sustained interest, preferred level of detail in responses, frequently referenced data categories, and recurring inquiry patterns, which can be included in interaction data 112. When determining what information to include in the user-specific input, the information parsing module 312 queries the memory store 310 to retrieve these historical interaction attributes and adjusts the selection and weighting of retrieved data entries to align with the retrieved patterns. For example, if the stored attribute data indicates that the user 302 typically requests detailed information on a particular subject area, the information parsing module 312 prioritizes data entries related to that subject area for inclusion in the user-specific input. If the stored attribute data indicates that the user 302 frequently references external research sources, the information parsing module 312 queries external resources such as web searches or external databases and includes relevant results in the user-specific input. The prioritization can include temporal weighting, such as assigning higher relevance scores to more recent data entries based on stored data indicating the user's preference for current information, thereby ensuring that the user-specific output transmitted to the user reflects the most contextually appropriate information.

The AI agent 304 can include or otherwise access a user profiling engine 314 that compiles information from multiple sources to generate a user-specific input for the AI agent 304. The user profiling engine 314 receives data tagged or flagged by the information parsing module 312 (e.g., data included in the briefing data structure 110, including the data used to display user interface 100b, advice from internal resources such as a research database maintained by an internal team or other analyses such as the peer entity analysis depicted in FIG. 2, or advice from external resources such as web searches) and aggregates this data to construct a comprehensive user profile. The user profiling engine 314 can incorporate newly identified concepts or preferences from the structured attribute data output by the summarization engine 308 into the user-specific input. The user profiling engine 314 can exclude data entries that are superseded by more recent information or that the user 302 has explicitly requested to omit. The user profiling engine 314 can adjust the weighting or relevance of data entries based on new evidence or updated relationship weights. In some implementations, the user profiling engine 314 performs conflict detection by comparing newly extracted attribute data against existing attribute data in the briefing data structure, and resolving inconsistencies before incorporating the data into the user-specific input.

In some implementations, the user profiling engine 314 can use one or more privacy-preserving architectures that protect the user-specific input from unauthorized access. For example, the data sources accessed by the user profiling engine 314 can be distributed across multiple computing nodes located in different physical or logical locations, where each node stores a partition of the structured attribute data associated with a subset of users or a subset of data categories. The user profiling engine 314 queries the distributed nodes and aggregates results without transferring raw attribute data to a central location, thereby reducing exposure of user-specific data when compiling the user-specific input. In some implementations, the user profiling engine 314 encrypts the user-specific input using cryptographic keys, such that the compiled profile remains unreadable without access to a corresponding decryption key. The decryption key can be stored separately from the encrypted data, held by the user 302, or managed by a key management service with access controls. In some implementations, the user profiling engine 314 partitions data such that the user-specific input associated with one user identifier is logically or physically isolated from user-specific inputs associated with different user identifiers, preventing cross-user data access.

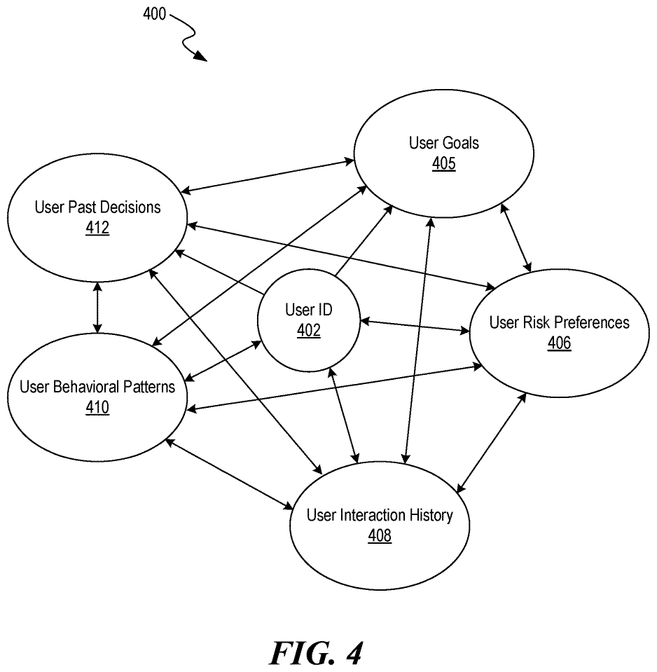

FIG. 4 shows a schematic illustrating an example environment 400 of a persistent data structure implemented by an avatar interaction platform, in accordance with some implementations of the present technology. The environment 400 can be implemented using components of example computer system 1000 illustrated and described in more detail with reference to FIG. 10. Likewise, implementations of example environment 400 can include different and/or additional components or can be connected in different ways.

A persistent data structure, such as the memory store 310 described with reference to FIG. 3, can be associated with a user identifier 402 that uniquely identifies an associated user. The user identifier 402 serves as a root node or primary key that links all user-specific information stored within the persistent data structure to a single user entity. The user identifier 402 can be implemented as a unique alphanumeric string, a hashed representation of user credentials, a universally unique identifier (UUID), or another identifier format that distinguishes one user from other users within the system.

User-specific information (e.g., briefing data structure 110) can be linked relationally to the user identifier 402 via a knowledge graph. The knowledge graph can be a data structure that represents information as a collection of nodes and edges, where each node represents a distinct concept or data entity, and each edge represents a relationship between two nodes. In the context of FIG. 4, the user identifier 402 can serve as a central node, and user-specific information nodes connect to the user identifier 402 through defined relationship edges. User goals 404 represent objectives or desired outcomes expressed by the user during prior interaction sessions, such as stated targets, declared intentions, or identified priorities. The user goals 404 node connects to the user identifier 402 via an edge indicating ownership or association. User risk preferences 406 represent the user's tolerance for uncertainty, variability, or potential negative outcomes, as expressed through explicit statements or inferred from behavioral patterns. User interaction history 408 represents a chronological record of prior exchanges between the user and the agent interface, including timestamps, session identifiers, and summaries of interaction content. User behavioral patterns 410 represent recurring tendencies observed across multiple interaction sessions, such as typical response lengths, preferred communication styles, common inquiry topics, or engagement frequency. User past decisions 412 represent choices or selections made by the user during prior interactions, such as accepted recommendations, rejected suggestions, or selected options from presented alternatives.

The knowledge graph defines edges between the user-specific information nodes that capture relationships beyond the direct connection to the user identifier 402. For example, an edge can link the user goals 404 node to the user risk preferences 406 node to indicate that a particular goal is constrained by a particular risk tolerance level. An edge can link the user past decisions 412 node to the user behavioral patterns 410 node to indicate that a prior decision contributed to an observed behavioral pattern. Each edge can carry associated properties, such as a weight indicating relationship strength, a timestamp indicating when the relationship was established, or a confidence score indicating the certainty of the inferred relationship. The knowledge graph structure enables traversal queries that retrieve related information by following edges from a starting node, such as retrieving all user goals 404 that are associated with a particular user risk preference 406.

In other implementations, the persistent data structure can be implemented using alternative architectures. A vector database implementation stores each piece of user-specific information as a numerical vector in a high-dimensional embedding space, where semantically similar information occupies nearby positions in the space. Relationships between information entries are determined by computing distance metrics, such as cosine similarity or Euclidean distance, between vector representations rather than through explicit edge definitions. A relational database implementation organizes user-specific information into tables with defined schemas, where each table stores a particular category of information such as goals, preferences, or decisions. Relationships between information entries are established through foreign key references that link rows across tables, and queries retrieve related information through join operations. A document database implementation stores user-specific information as semi-structured documents, such as JSON or XML records, where each document contains nested fields representing different attributes. Relationships between documents are established through embedded references or through separate index structures that map related documents.

In some implementations, the persistent data structure can employ privacy-preserving architectures that protect the user-specific information from unauthorized access. A federated implementation distributes the persistent data structure across multiple computing nodes located in different physical or network locations, where each node stores a partition of the user-specific information. The partitioning can be performed by user identifier 402, such that all information associated with a particular user resides on a single node, or by information category, such that all user goals 404 reside on one node and all user risk preferences 406 reside on another node. Query processing occurs at the distributed nodes, and only aggregated or anonymized results are transmitted to a central location, reducing exposure of raw user-specific information. An encrypted implementation applies cryptographic transformations to the user-specific information before storage, such that the stored data remains unreadable without access to a corresponding decryption key. The encryption can be applied at the field level, encrypting individual values such as specific goals or preferences, or at the record level, encrypting entire nodes or documents. The decryption key can be managed by the user, stored in a separate key management system with access controls, or derived from user credentials at query time. A differential privacy implementation adds controlled noise to query results returned from the persistent data structure, such that individual user-specific information cannot be precisely reconstructed from the query results while aggregate patterns across multiple users remain statistically valid.

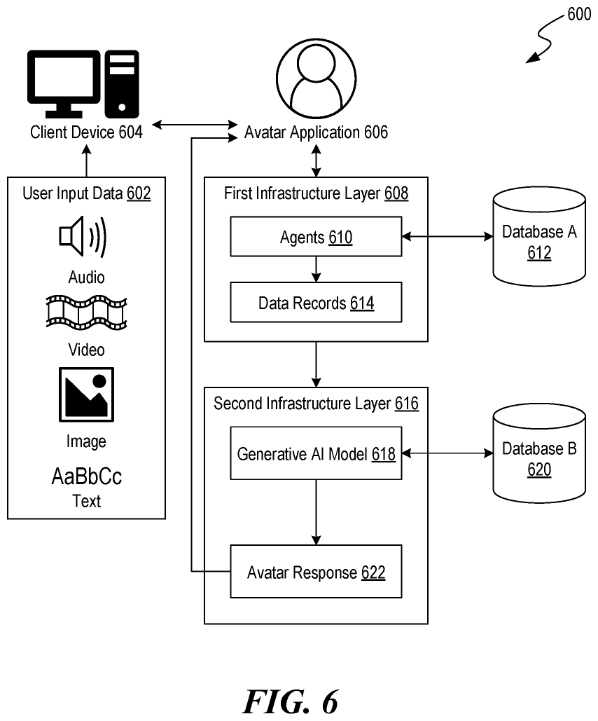

In some implementations, the avatar interaction platform can enforce compliance with regulatory frameworks such as those governing protected health information, financial data confidentiality, and cross-border data transfer restrictions by applying privacy-preserving operations at multiple stages of the data processing pipeline. The persistent data structure can implement field-level encryption that applies cryptographic transformations to individual attribute values before storage, such that sensitive information such as account balances, medical diagnoses, or transaction details remains unreadable without access to a corresponding decryption key managed by a key management service with role-based access controls. The avatar interaction platform can further implement data residency controls that restrict storage of user-specific information to computing nodes located within geographic boundaries specified by applicable regulatory requirements, and can apply differential privacy techniques that add controlled noise to query results to prevent reconstruction of individual user records from aggregated outputs. The gateway engine described with reference to FIG. 6 can enforce data minimization by redacting sensitive information patterns from data records before transmission across infrastructure boundaries, thereby reducing exposure of regulated data to external processing environments.

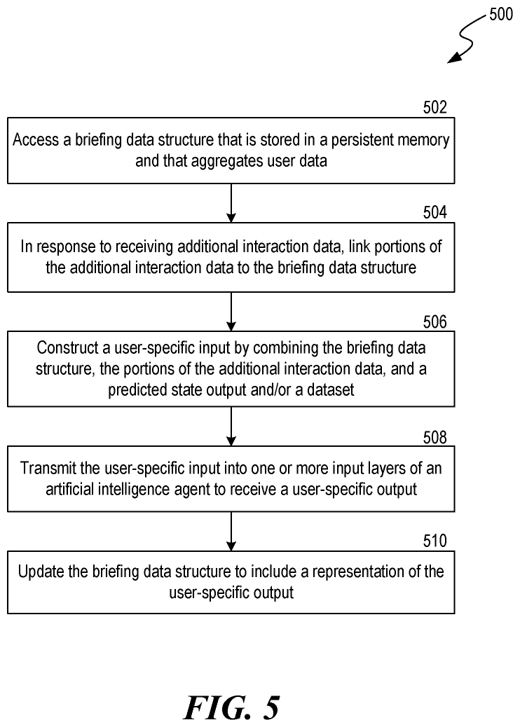

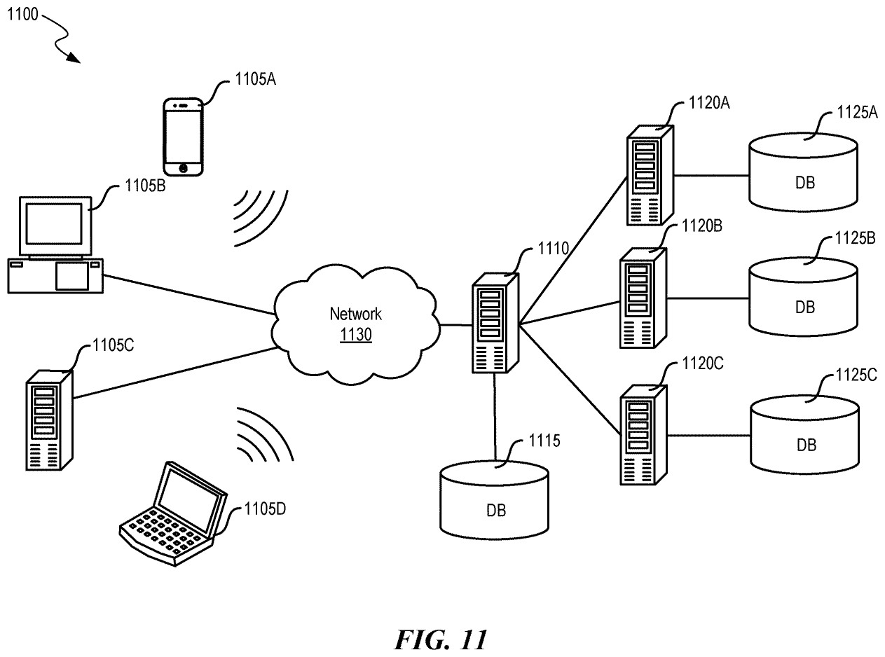

FIG. 5 is a flow diagram illustrating an example process of implementing a persistent relational memory architecture using an avatar interaction platform, in accordance with some implementations of the present technology. In some implementations, the example process 500 is performed by a system (e.g., the avatar interaction platform) including components of the example computing environment illustrated and described in more detail with reference to FIG. 11. The system can be implemented on a terminal device, on a server, or on a telecommunications network core. In some implementations, the example process 500 is performed by the AI agent itself. In some implementations, the example process 500 is performed by a separate system or module distinct from the AI agent, such that the separate system or module performs one or more of the operations and transmits the reasoning output to the AI agent for generating the user-specific output. Likewise, implementations can include different and/or additional operations or can perform the operations in different orders.

In operation 502, the avatar interaction platform can (e.g., via an information parsing module that queries the memory store to retrieve stored attribute data corresponding to user inputs, such as information parsing module 312) access (or otherwise obtain or receive) a briefing data structure (or another type of data input) that is stored in a persistent memory and that aggregates user data. The user data can include observed interaction data between a user and an artificial intelligence agent across a plurality of interaction sessions. For example, the interaction data can be data as described with reference to interaction data 112 in FIG. 1A. The user data can include time-series data, for example as described with reference to user time-series data 114 in FIG. 1A. In some implementations, the observed interaction data and/or the time-series data can be sequentially aggregated within the briefing data structure (e.g., stored by the conversation capture module 306 in a sequential record as described with reference to FIG. 3). Sequential aggregation preserves the temporal ordering of interaction events, which enables the artificial intelligence agent to identify causal relationships between user inputs and subsequent behavioral patterns. For example, the sequential ordering enables the system to determine that a user preference expressed in a first interaction session influenced a decision made in a subsequent interaction session, thereby supporting more accurate inference of user intent evolution over time.

The briefing data structure can be stored in a persistent memory (e.g., a persistent data structure that maintains user-specific information through interconnected nodes and edges organized as a knowledge graph, such as the persistent data structure described with reference to environment 400 of FIG. 4) that is accessible to an avatar interface (e.g., an avatar application executing on a client device that renders an AI avatar interface structured to present audiovisual signals in response to natural language inputs, such as avatar application 606) configured to host the artificial intelligence agent. For example, the persistent memory can be implemented as a persistent data structure of example environment 400 described with reference to FIG. 4. For another example, the avatar interface can be described in more detail with reference to the example environment 600 of FIG. 6.

In operation 504, in response to receiving additional interaction data (e.g., interaction data received after or in addition to interaction data accessed from the persistent memory), the avatar interaction platform can link (e.g., map, associate) portions of the additional interaction data to the briefing data structure. In some implementations, linking portions of the additional interaction data to the briefing data structure may include identifying portions of the additional interaction data that correspond to the briefing data structure. For example, the information parsing module 312 can generate a vector embedding of the additional interaction data and perform a similarity search against vector embeddings of records stored in the briefing data structure to identify stored attribute data entries whose embeddings fall within a threshold distance in the embedding space. When the additional interaction data includes a user query about investment performance, the information parsing module 312 can extract topic identifiers from the query and traverse edges in the knowledge graph of the persistent data structure to retrieve user risk preferences 406 and user goals 404 that are linked to investment-related nodes. In some implementations, linking portions of the additional interaction data to the briefing data structure can be performed using rule-based matching that applies predefined association rules to identify correspondences between input patterns and stored attribute categories. The rule-based matching can operate in conjunction with or as an alternative to vector-based similarity searches, enabling the system to identify correspondences based on explicit criteria such as keyword matches, entity references, or temporal proximity to prior interactions.

The information parsing module 312 can further retrieve user time-series data 114 from the briefing data structure, such as historical portfolio values or account balances, and identify temporal patterns in the time-series data that correspond to the subject matter of the additional interaction data. For instance, if the additional interaction data references a particular time period, the information parsing module 312 can filter the user time-series data 114 to extract data points within that time period and link those data points to the additional interaction data for inclusion in the user-specific input. The information parsing module 312 can also retrieve user behavioral patterns 410 from the briefing data structure to determine how to prioritize and weight the linked information based on the user's historical interaction preferences, such as preferred level of detail or frequently referenced data categories.

In some implementations, the system can use a user identifier associated with the user to link the additional information to the briefing data structure. For example, the system can use the user identifier 402 as a primary key to traverse the knowledge graph of the persistent data structure and establish edges between the additional interaction data and existing nodes such as user goals 405, user risk preferences 406, user interaction history 408, user behavioral patterns 410, and user past decisions 412 that are already linked to the user identifier 402.

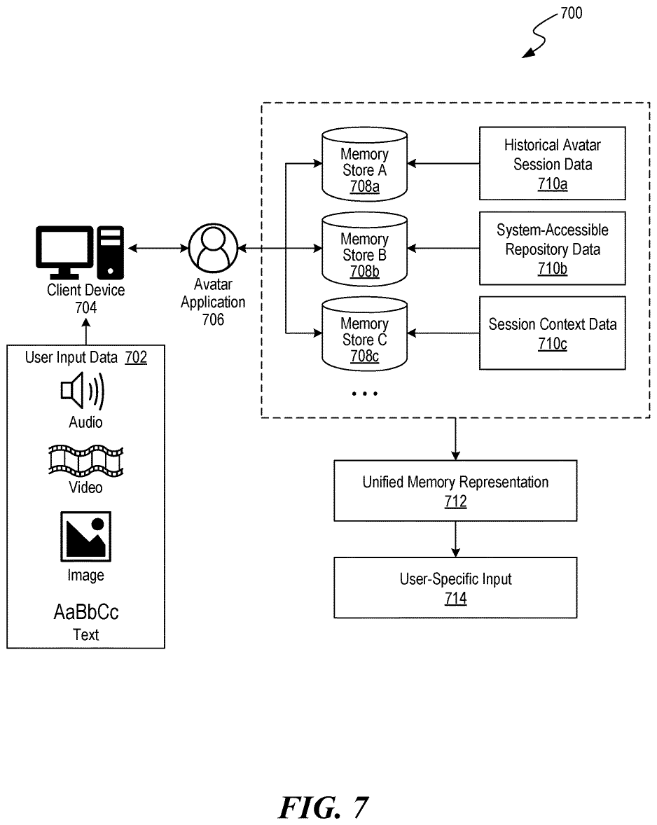

In operation 506, the avatar interaction platform can construct a user-specific input by combining (e.g., into a unified memory representation 712 and/or a user specific input 714 as described with reference to example environment 700 of FIG. 7) the briefing data structure, the portions of the additional interaction data, and a predicted state output and/or a dataset. The predicted state output can be generated using an artificial intelligence model (e.g., as a part of the artificial intelligence agent or outside the perimeters of the artificial intelligence agent) using the observed interaction data from the briefing data structure. For example, the artificial intelligence model can analyze the user time-series data 114 from the briefing data structure to identify temporal patterns such as secular trends, seasonal variations, or cyclical fluctuations, and generate the predicted state output as a forecast of future state variables based on those identified patterns. The predicted state output can represent anticipated changes in metrics such as account balances, portfolio values, or rates of return over a projected time period. In some implementations, the avatar interaction platform can retrieve or otherwise obtain the user-specific input, which can include the briefing data structure, the portions of the additional interaction data, and the predicted state output and/or the dataset.

The dataset can be retrieved from one or more repositories (e.g., internal repositories or external repositories). For example, internal repositories can include enterprise databases storing client account information, transaction histories, or research databases maintained by internal teams, and external repositories can include third-party data providers, public market data feeds, or web-based information sources accessible through APIs. In some implementations, the dataset can include a peer information set or a historic dataset. For example, a peer information set can be a collection of data records describing one or more peer entities that have been identified as sharing similar characteristics with the user, such as demographic attributes, financial profiles, or behavioral patterns, along with associated item characteristic data such as portfolio holdings, rates of return, or risk metrics. For example, the peer information set can include return on investment values aggregated across peer entities within an entity cluster into which the user has been classified, enabling generation of comparative analyses such as the asset changes depicted in FIG. 2. A historic dataset can be a collection of time-series records describing past performance metrics, such as historic portfolio performance, historic market returns, or historic transaction outcomes, over one or more prior time periods.

In some implementations, the avatar interaction platform can determine (e.g., identify, select) for the user an entity cluster (e.g., a peer group or set of peer entities) within a plurality of entity clusters using the briefing data structure as input into a machine learning model (e.g., AI agent 304 described with reference to FIG. 3 or another AI agent, machine learning model, or artificial intelligence model). For example, the machine learning model can compare current state characteristics of the user represented in the briefing data structure against corresponding characteristics of entities in each of the plurality of entity clusters to identify the entity cluster whose characteristics most closely match those of the user. In some examples, the machine learning model has been trained to classify the user into the entity cluster of the plurality of entity clusters (e.g., using a scikit-learn KMeans clustering algorithm). The avatar interaction platform can use the machine learning model to identify one or more peer entities associated with (e.g., included in) the entity cluster and can generate an item characteristic dataset for the entity cluster based on the one or more peer entities included in the entity cluster. The item characteristic dataset can include performance data, probability data, or outcome data (e.g., about the one or more peer entities). For example, the performance data, probability data, and outcome data can include financial information (e.g., account balances, holdings), performance metrics (e.g., historical rates of return, portfolio returns), and projections (e.g., forecasted future state variables, projected account values). The avatar interaction platform can then determine a plurality of items for the peer information set for the entity cluster based on the item characteristic dataset (e.g., adding representations of the performance data, the probability data, and/or the outcome data to the peer information set).

In some implementations, the avatar interaction platform can receive an indication (e.g., a pointer, filepath) of the one or more data repositories where the dataset can be located, stored, or otherwise logged. The avatar interaction platform can search the repositories for datasets to use in generating the user-specific input using a deterministic search query (e.g., a structured query with predefined parameters and filtering criteria that returns consistent results for identical inputs, such as a SQL statement or a parameterized API request). In some implementations, the system can use a large language model (e.g., AI agent 304 described with reference to FIG. 3 or another AI agent, machine learning model, or artificial intelligence model) to generate a deterministic search query based on the portions of the additional interaction data. In some implementations, the system can retrieve the deterministic search query from a predetermined set of search queries (e.g., a database or other list) based on the one or more portions of the additional interaction data. The system can then retrieve the historic dataset using the deterministic search query.

In some implementations (e.g., in addition to or alternatively to using a deterministic search query), the avatar interaction platform can use embeddings of the additional interaction data to retrieve the dataset from the repositories. In particular, the avatar interaction platform can generate a vector embedding (e.g., an array of numerical values that encodes the semantic meaning of the additional interaction data such that semantically similar content is mapped to nearby coordinates in a multi-dimensional space) for the one or more portions of the additional interaction data. For example, the system can use a generative model or other AI model to transform the additional interaction data into a vector embedding (or multiple vector embeddings). The avatar interaction platform can then query external resources (e.g., external repositories or internal repositories) using the vector embedding to retrieve the historic dataset. For example, the avatar interaction platform can compare the vector embedding of the additional interaction data against vector embeddings of records or descriptions, summaries, or representations of records stored in the repositories by computing a distance metric (e.g., cosine similarity, Euclidean distance) between the embeddings to identify candidate records whose embeddings fall within a threshold distance in the embedding space. The avatar interaction platform can then retrieve, as the historic dataset, the candidate records whose distance metric satisfies the threshold, thereby returning records that are semantically similar to the additional interaction data even when the records do not contain exact keyword matches.

In some implementations, the avatar interaction platform can generate the predicted state output. In particular, the avatar interaction platform can select a dataset from a plurality of historic datasets based on similarities between state characteristics of the dataset and one or more present states of time-series data included in the briefing data structure. Similarities between state characteristics of the dataset and present states of time-series data in the briefing data structure can include correspondences in values, trends, or patterns observed across comparable variables, such as matching ranges of account balances, similar rates of return over a given interval, or analogous trajectories in portfolio values. For example, the avatar interaction platform can compute a distance metric (e.g., Euclidean distance, dynamic time warping) between a window of present state values from the time-series data and corresponding windows in the historic datasets to identify the dataset whose state characteristics most closely align with the present states. The dataset can include rate-of-change data over a first time period. For example, the rate-of-change data can represent magnitudes of change in portfolio values, account balances, or other tracked metrics measured between successive timestamps within the first time period.

The system can detect a rate-of-change event in the dataset by comparing the rate-of-change data to a threshold rate of change and generate a normalized rate-of-change event by time-shifting the rate-of-change event from the first time period to correspond to a time during a second time period associated with the time-series data. Time-shifting the rate-of-change event can include adjusting the timestamps associated with the rate-of-change event such that the event aligns with a corresponding time point within the second time period rather than remaining anchored to its original time point within the first time period. This time-shifting operation enables the avatar interaction platform to apply patterns observed in historical data to current time-series data by mapping the temporal position of the rate-of-change event from its original occurrence in the first time period to an analogous temporal position in the second time period, thereby preserving the magnitude and shape of the rate-of-change event while repositioning it to inform predictions about the second time period.

Normalizing the rate-of-change event can include scaling the magnitude of the event based on differences between baseline values in the first time period and the second time period, adjusting for seasonal or cyclical factors that differ between the time periods, or applying transformation functions that account for changes in the user's circumstances between the time periods. The normalization ensures that patterns observed in historical datasets remain applicable to current predictions despite differences in absolute values or contextual factors. The avatar interaction platform can generate the predicted state output by applying the normalized rate-of-change event to first rate-of-change data generated by the artificial intelligence model for the second time period. By applying the normalized rate-of-change event to the first rate-of-change data generated for the second time period, the avatar interaction platform can produce a predicted state output that reflects how the user's current time-series data is likely to evolve based on patterns observed in historically analogous datasets. In some implementations, the predicted state output can be generated using statistical models that do not require neural network architectures, such as autoregressive models that extrapolate future values based on weighted combinations of prior values in the time-series data, or ensemble methods that aggregate predictions from multiple simpler models to produce a composite forecast.

In operation 508, the avatar interaction platform can transmit (e.g., upload, provide) the user-specific input into one or more input layers of an artificial intelligence model (e.g., as input data to the data reception layers of AI agent 304 described with reference to FIG. 3 or another AI agent, machine learning model, or artificial intelligence model such that the artificial intelligence model can process the user-specific input through its forward propagation) to receive a user-specific output. For example, the user-specific output can be a finished avatar response (such as the avatar response 622 described with reference to FIG. 6) that includes an audio stream, a video stream, a text response, or a combination thereof, that is rendered via the avatar interface to present information responsive to the additional interaction data. In some implementations, the user-specific output can be an intermediate data structure generated by the artificial intelligence model, such as a set of recommended actions, a ranked list of candidate responses, a predicted state value, or a structured data object, that is subsequently processed by downstream components (e.g., a rendering engine, a synthesis module) before being presented to the user.

In some implementations, the user-specific output can be generated responsive to the user-specific input (e.g., reflects the briefing data structure, the additional interaction data, the predicted state output, and/or the dataset). For example, if the additional interaction data includes a request from the user for a specific analysis (e.g., a comparison of the user's portfolio performance against a peer group, a projection of future account balances over a specified time horizon, or an evaluation of the user's progress toward a stated goal), and that request is incorporated into the user-specific input transmitted to the one or more input layers of the artificial intelligence agent, the artificial intelligence agent can generate a user-specific output that reflects the requested analysis. The user-specific output can include, for example, an analysis generated based on the briefing data structure (e.g., using the observed interaction data and/or user time-series data aggregated therein), the predicted state output (e.g., using forecasted future state variables generated by the artificial intelligence model), and/or the dataset (e.g., using a peer information set or historic dataset retrieved from the one or more data repositories). For instance, if the user requests an analysis of how their portfolio returns compare to those of similarly situated peers, the artificial intelligence agent can generate a user-specific output that combines the user's current state characteristics from the briefing data structure with the peer information set retrieved from the one or more data repositories to produce a comparative analysis responsive to the user's request.

In some implementations, the user-specific output can be generated using the persistent memory. In particular, the avatar interaction platform can query a knowledge graph (e.g., the knowledge graph described with reference to the memory store 310 of FIG. 3) of the persistent memory by traversing one or more relational nodes of the knowledge graph to identify a subset of the briefing data structure corresponding to the additional interaction data. For example, the subset of the briefing data structure can include attribute data entries linked to nodes corresponding to topics, entities, or preferences referenced in the additional interaction data. The avatar interaction platform can identify a correspondence between the additional interaction data and the subset of the briefing data structure. For example, the information parsing module 312 described with reference to FIG. 3 can measure a degree of correspondence, for example by determining a cosine similarity or counting matching weighted keywords.

If the correspondence meets a similarity threshold (e.g., a numerical threshold, a threshold condition, or a similarity indication), the avatar interaction platform can use the artificial intelligence model (e.g., AI agent 304 described with reference to FIG. 3 or another AI agent, machine learning model, or artificial intelligence model) to generate one or more user recommendations (e.g., recommendations described with reference to user interface 100b of FIG. 1B) based on the subset of the briefing data structure, the one or more portions of the additional interaction data, one or more portions of the predicted state output, and/or the dataset. For example, the artificial intelligence model can apply reasoning (e.g., chain-of-thought reasoning that traverses the relational nodes of the knowledge graph) to evaluate how the subset of the briefing data structure (e.g., prior user goals 405, user risk preferences 406, user past decisions 412) constrains candidate recommendations derived from the additional interaction data, the predicted state output, and/or the dataset.

In some implementations, the avatar interaction platform can provide the subset of the briefing data structure, the one or more portions of the additional interaction data, and the predicted state output and/or the dataset from the repository as input to the artificial intelligence model. The artificial intelligence model can generate the user-specific output per constraints defined by the knowledge graph. In particular, the user-specific output can be constrained by the one or more relational nodes of the knowledge graph. For example, if the knowledge graph includes a relational node representing a user risk preference 406 that indicates a low tolerance for variability, the user-specific output can be constrained to exclude recommended actions associated with volatility levels exceeding a threshold defined by the relational node. In another example, if the knowledge graph includes a relational node representing a user goal 405 that indicates a target rate of return, the user-specific output can be constrained to identify recommended actions whose projected outcomes align with the target rate of return defined by the relational node. The user-specific output can identify one or more recommended actions based on the subset of the briefing data structure, the one or more portions of the additional interaction data, the predicted state output and/or the dataset (e.g., recommendations described with reference to user interface 100b of FIG. 1B).

In operation 510, the avatar interaction platform can update (e.g., change, add-to, augment) the briefing data structure to include a representation of the user-specific output. The representation of the user-specific output can take various forms (for example, depending on the implementation of the persistent memory). For example, the representation can be a structured attribute data entry including key-value pairs that encode the content of the user-specific output, a vector embedding generated by processing the user-specific output through an embedding model that transforms the output into a fixed-length numerical array, one or more nodes added to a knowledge graph of the briefing data structure (e.g., links to user goals 405, user risk preferences 406, user past decisions 412), a row inserted into a relational schema table, or a condensed summary generated by a summarization engine (e.g., summarization engine 308) that extracts salient information from the user-specific output and discards redundant content, thereby reducing storage consumption while preserving information used for future retrieval operations. In some implementations, the updated briefing data structure can be stored back into the persistent memory and made accessible to the avatar interface for use during subsequent interaction sessions.

### Example Infrastructure Architectures Used by the Avatar Interaction Platform

FIG. 6 shows a schematic illustrating an example environment 600 of deploying an AI avatar using an avatar interaction platform, in accordance with some implementations of the present technology. The environment 600 can be implemented using components of example computer system 1000 illustrated and described in more detail with reference to FIG. 10. Likewise, implementations of example environment 600 can include different and/or additional components or can be connected in different ways.

The avatar interaction platform is enabled to receive (e.g., obtain, access) user input data 602 via a client device 604 communicatively connected to an avatar application 606. For example, the user input data 602 includes audio data captured through a microphone of the client device 604 that records spoken utterances from a user. The audio data can be encoded into a digital format by sampling the analog audio signal at a specified sampling rate and converting the samples into a compressed audio format. In another example, the user input data 602 includes video data captured via a camera of the client device 604 that records facial expressions or gestures from the user. The video data can refer to sequential image frames. In yet another example, the user input data 602 includes text data entered through a keyboard or touchscreen interface of the client device 604. The text data can be captured as character sequences.

The client device 604 refers to a computing device having at least one processor and memory that executes software applications and transmits data over network connections. For example, the client device 604 is a mobile phone that captures voice commands from a user and transmits the voice commands over a cellular network connection. The mobile phone processes the voice commands by executing the avatar application 606 on a mobile operating system. In another example, the client device 604 is a wearable electronic device such as augmented reality (AR) glasses that overlay visual representations of the AI avatar onto the user's field of view while capturing voice commands through a microphone. The AR glasses render the visual representations by projecting images onto transparent display elements positioned in front of the user's eyes. The avatar application 606 refers to a software application executing on the client device 604 that renders an AI avatar interface structured to present audiovisual signals in response to natural language inputs received from a user. The avatar application 606 can process the user input data 602 by transmitting the user input data 602 to the first infrastructure layer 608.

The avatar application 606 can be communicatively connected with a first infrastructure layer 608 that includes agent(s) 610. The connection between the avatar application 606 and the first infrastructure layer 608 can be established by initiating a network session that authenticates the client device 604 using credentials such as authentication tokens or digital certificates. In some implementations, the first infrastructure layer 608 operates as an internal infrastructure layer controlled by an enterprise entity that operates within a private network perimeter. The private network perimeter restricts access to authorized devices and users by filtering incoming network traffic based on source addresses and connection parameters.

The agents 610 refer to autonomous software modules that are each trained on distinct domain-specific knowledge bases and execute programmatic function calls to APIs to retrieve domain-specific information from backend data repositories. A knowledge base refers to a structured collection of information organized around a specific subject domain. Each agent within the agents 610 can be exposed to labeled training data that associates example user inputs with corresponding intents and entities. For example, a first agent within the agents 610 can be trained on a client profile knowledge base that enables the first agent to identify when the user input data 602 contains queries about account status by detecting keywords related to account information and constructing requests to retrieve user account details from backend systems. The requests can be constructed by populating request templates with parameters extracted from the user input data 602 such as user identifiers and account numbers. The agents 610 execute function calls by transmitting the requests to backend systems that process the requests and return structured data responses in formats that contain the requested information organized into key-value pairs.

The agents 610 can be used to generate one or more data records 614 by retrieving information from backend systems in response to the user input data 602. The agents 610 can access a first database 612 to retrieve the one or more data records 614 by executing database queries that filter records based on criteria derived from the user input data 602. The first database 612 refers to a structured data repository that stores client information such as user account information, transaction histories, and/or service-related data accessible through query operations. A structured data repository organizes data into predefined formats with defined relationships between data elements. The structured data repository can organize data into tables with defined schemas where each table represents a different category of information such as user profiles or transaction logs. Each table can include rows that represent individual records and columns that represent data fields within those records.

The agents 610 can retrieve the one or more data records 614 by executing queries against the first database 612 that filter records based on user identifiers extracted from the user input data 602 using authentication tokens or session identifiers. The queries refer to statements that specify which columns to retrieve and conditions that define filtering criteria based on the user identifiers. In some implementations, the agents 610 execute multiple parallel queries to the first database 612 to retrieve different categories of data records simultaneously by spawning separate execution threads that each query a different table within the first database 612. The parallel execution reduces the total retrieval time by allowing multiple database operations to proceed concurrently rather than sequentially. The data records 614 can include structured data entries containing fields relevant to the user input data 602. Each data record within the data records 614 includes key-value pairs that associate data field names with corresponding data values stored in specific data types such as text strings or numerical values. For example, a data record includes an account balance field paired with a numerical value representing the current balance expressed in a currency denomination.

The data records 614 can be transmitted from the first infrastructure layer 608 to a second infrastructure layer 616 via a network connection that spans the boundary between the two infrastructure layers. In some implementations, the data records 614 are transmitted through a gateway engine that validates the data records 614 against one or more criteria (e.g., guidelines, rules) before allowing transmission to the second infrastructure layer 616. The gateway engine can detect sensitive information patterns such as social security numbers or credit card numbers and redact or mask the sensitive information by replacing it with placeholder values, synthetic values, and so forth. The second infrastructure layer 616 includes one or more generative AI models 618 hosted on computing resources within the second infrastructure layer 616.

The one or more generative AI models 618 refer to neural network-based models that process input data to generate natural language text, audio streams, or visual streams as outputs through forward propagation operations that transform input tensors into output tensors. A tensor refers to a multi-dimensional array of numerical values. The forward propagation operations pass the input data through multiple layers of the neural network where each layer applies one or more transformations to produce intermediate representations that are progressively refined until the final output is generated.

The one or more generative AI models 618 can use a second database 620 to generate an avatar response 622 by retrieving supplemental information that grounds the outputs in verifiable facts. The second database 620 refers to a knowledge base containing information sources (e.g., pre-approved, verified) used for grounding outputs of the one or more generative AI models 618 to ensure factual accuracy. Grounding refers to the process of connecting generated outputs to verified information sources to reduce the likelihood of generating false or unsupported statements. For example, the knowledge base stores curated content such as policy documents or product specifications that have been verified for accuracy by domain experts.

The one or more generative AI models 618 access the second database 620 by executing search queries that retrieve particular information based on semantic similarity between the data records 614 and content stored in the second database 620. Semantic similarity is a measure of how closely related two pieces of text are in meaning rather than in exact wording. The search queries are executed by generating vector embeddings of the data records 614 through an embedding model that transforms text into high-dimensional vectors representing semantic meaning. A vector embedding is a numerical representation of text where semantically similar texts are mapped to nearby points in a multi-dimensional space. The vector embeddings are compared against vector embeddings of content in the second database 620 using similarity calculations that measure the distance between vectors to identify particular information sources. The one or more generative AI models 618 can generate the avatar response 622 by combining information from the data records 614 with information retrieved from the second database 620 using the retrieved context with the data records 614 as input.

The avatar response 622 includes at least one of an audio stream or a corresponding visual stream that presents information responsive to the user input data 602. An audio stream refers to a continuous sequence of audio data transmitted over a network connection that can be played back in near-real-time or real-time. In some implementations, the avatar response 622 includes an audio stream that contains synthesized speech generated by converting generated text responses into audio waveforms. The avatar response 622 can include a video stream that displays an animated avatar representation speaking the synthesized speech using a video rendering model that maps speech sounds to corresponding visual animations (e.g., mouth shapes). In some implementations, the avatar response 622 includes other modalities of communication, such as text, haptic signals, or other modalities to convey information (e.g., instructions to convert to American sign language).

The avatar response 622 can be transmitted back to the avatar application 606. In some implementations, the avatar response 622 is transmitted from the second infrastructure layer 616 to the first infrastructure layer 608 in a streaming data format, which refers to organizing data for continuous transmission where data is sent in sequential chunks that can be processed as they arrive rather than waiting for complete transmission. In some implementations, the avatar response 622 is validated by a gateway engine within the first infrastructure layer 608 before being forwarded to the avatar application 606 by applying output validation rules that check for prohibited content patterns or compliance violations. The avatar application 606 receives the avatar response 622 and renders the audio stream and/or the corresponding video stream on the client device 604 by presenting content through output devices such as speakers that play audio or displays that present visual frames to the client device 604.

### Example Memory Synchronization Architectures Used by the Avatar Interaction Platform

FIG. 7 shows a schematic illustrating an example environment 700 of an architecture implemented by an avatar interaction platform to synchronize memory from multiple sources, in accordance with some implementations of the present technology. The environment 700 can be implemented using components of example computer system 1000 illustrated and described in more detail with reference to FIG. 10. Likewise, implementations of example environment 700 can include different and/or additional components or can be connected in different ways. Components of the architecture illustrated by example environment 700 may be used by or with information parsing module 312 and/or user profiling engine 314 described with reference to FIG. 3.

The avatar interaction platform is enabled to receive (e.g., obtain, access) user input data 702 via a client device 704 communicatively connected to an avatar application 706. The user input data 702 refers to information captured from a user during a communication session with an AI avatar (such as the user input data 602 in FIG. 6). The user input data 702 can include audio data captured through a microphone of the client device 704 that records spoken utterances from the user. In some implementations, the user input data 702 includes video or image data captured via a camera of the client device 704 (or otherwise uploads the video or image data) that records facial expressions or other gestures from the user. In some implementations, the user input data 702 includes text data entered through a keyboard or touchscreen interface of the client device 704.

The client device 704 (such as the client device 604 in FIG. 6) refers to a computing device having at least one processor that executes machine-readable instructions and at least one memory module that stores data and instructions for access by the processor. The avatar application 706 (such as the avatar application 606 in FIG. 6) refers to a software application executing on the client device 704 that renders or otherwise presents an AI avatar interface structured to present audiovisual signals in response to natural language inputs received from the user.

The avatar application 706 can be communicatively connected with multiple memory data structures such as memory stores 708 (e.g., a first memory store 708a, a second memory store 708b, a third memory store 708c). A memory store 708 refers to a data repository that maintains records of interaction history and/or other contextual information accessible by the avatar interaction platform during communication sessions. Each memory store 708 can organize respective data into structured formats with defined schemas that specify the data types and field names for each record. The memory stores 708 can be implemented as relational databases that organize data into tables where each table contains rows representing individual records and columns representing data fields within those records. Thus, the relational database enforces referential integrity constraints that define relationships between tables, such as a foreign key constraint that links a record in a session table to a corresponding record in a user table. In some implementations, the memory stores 708 are implemented as document databases that store records as self-contained documents. For example, each document includes key-value pairs that define the fields and values for a single record, and the document database indexes specified fields to enable retrieval of documents matching query predicates.

The avatar application 706 can establish connections to the memory stores 708 by transmitting a connection request through a network interface. Each connection request can include authentication credentials such as an access token that encodes the identity of the requesting application and the permissions granted to that application. The memory store 708 can validate the access token by verifying a cryptographic signature or other authentication credential appended to the token and validating that the permissions encoded in the token authorize the requested operation.

Each memory store 708 can represent and store different data 710 (e.g., historical avatar session data 710a, system-accessible repository data 710b, session context data 710c). For example, the first memory store 708a stores historical avatar session data 710a, the second memory store 708b stores system-accessible repository data 710b, and the third memory store 708c stores session context data 710c. The separation of data 710 across distinct memory stores 708 enables the avatar interaction platform to apply different access controls to each category of data 710. For example, the avatar interaction platform can restrict access to the second memory store 708b to authorized personnel who are permitted to view records from external engagements, and grant broader access to the third memory store 708c for session context data 710c that is used during active communication sessions.

The separation further enables the avatar interaction platform to apply different retention policies to each category of data 710. For example, the avatar interaction platform can retain historical avatar session data 710a in the first memory store 708a for an extended duration (e.g., multiple years) to enable long-term personalization, and clear session context data 710 c from the third memory store 708 c after a shorter duration (e.g., 24 hours following session termination) to reduce storage consumption. In some implementations, the memory stores 708 are co-located within a single database instance but partitioned into separate logical containers that isolate each category of data 710 while sharing underlying storage infrastructure. The logical containers can be implemented as separate schemas or namespaces within the database instance, where each schema defines the table structures and access permissions for its contained data.

Historical avatar session data 710a refers to records generated by an AI avatar during prior communication sessions with a user. The historical avatar session data 710a includes prior user inputs submitted by the user during those sessions. Each user input can be stored as a record containing a text field that holds the content of the input (or a reference to an audio, image, or video file if the input was non-textual) and/or one or more metadata fields that indicate, for example, the timestamp identifying when the input was received and/or a session identifier that associates the input with a particular communication session. The session identifier refers to a unique value assigned when the communication session is initiated and can be used to group all records belonging to that session. Each avatar response can be stored as a record containing a field that indicates the generated response content and/or metadata fields that indicate the timestamp identifying when the response was generated and/or a reference to the user input record that prompted the response.

In some implementations, the historical avatar session data 710a includes derived information extracted from the prior communication sessions. The derived information can include topic labels assigned to each session, where a topic label refers to a value or a categorical value (e.g., “account inquiry” or “product information”) determined by a classification model, rule-based system, and so forth. The determined information can include user preference indicators inferred from patterns of user behavior across multiple sessions, where a user preference indicator can be represented as a key-value pair that captures a characteristic of how the user prefers to interact with the AI avatar (e.g., brief interactions).

System-accessible repository data 710b refers to records generated by an during engagements with the user that occurred independently of the AI avatar or using data sources outside of the historical avatar session data. Examples of system-accessible repository data 710b can include time-series data representing temporal sequences of user-related information such as account balances, portfolio values, or transaction histories tracked over successive time periods; peer entity analyses or underlying data used to generate peer entity analyses such as item characteristic datasets containing performance data, probability data, or outcome data associated with entity clusters; external research data retrieved from internet searches, third-party data providers, or public market data feeds; internal documents and databases such as enterprise databases storing client account information, research databases maintained by internal teams, or policy documents; and communications between the user and agents or representatives that occurred through channels other than the avatar application 706, such as email correspondence, call transcripts, or notes documented by representatives during direct engagements with the user. In some implementations, the external source can include an automated system that captures interaction data from channels other than the avatar application 706. For example, an email processing system can capture information from email correspondence between the user and organizational representatives and store the captured information as records in the second memory store 708b.

Session context data 710c refers to records captured during a current communication session. The session context data 710c includes user input data received from the user since the communication session was initiated. Each user input can be stored in a sequence data structure that preserves the order in which inputs were received, where the sequence data structure can be implemented as an ordered list or array that appends each new input to the end of the list. The session context data 710c includes avatar response data generated by the AI avatar since the communication session was initiated. Each avatar response can be stored in association with the user input that prompted the response by including a reference field in the avatar response record that contains the identifier of the corresponding user input record.

The session context data 710c can include state information that tracks the current status of the communication session. The state information refers to a current topic field that holds a label indicating the subject matter currently being discussed, where the label can be updated each time the avatar interaction platform detects a topic change. The state information can include, for example, a pending questions list that defines references to user inputs that have been identified as questions but have not yet been fully addressed by the AI avatar, where each reference is removed from the list when the avatar interaction platform determines that a subsequent avatar response has addressed the corresponding question. In some implementations, the third memory store 708c clears the session context data 710c after the communication session terminates by deallocating the memory regions used to store the session data. In some implementations, the third memory store 708c archives the session context data 710c to persistent storage before clearing by writing the session data to the first memory store 708a as a new historical avatar session record.

In some implementations, the avatar interaction platform uses a single unified memory store rather than separate memory stores 708 for each category of data 710. The unified memory store maintains all records in a common storage structure implemented as a single database or data lake. Each record in the unified memory store can include a source tag field that contains a categorical value indicating whether the record originated from historical avatar sessions or historical external sessions or the current session context. Each record can include a category tag field that contains a categorical value indicating the type of information contained in the record (e.g., user input, avatar response, user preference). The avatar interaction platform can filter records by source tag and category tag when retrieving data for a specific purpose.

In some implementations, the avatar interaction platform uses a hierarchical memory architecture in which the third memory store 708c operates as a cache layer positioned between the avatar application 706 and the first memory store 708a and the second memory store 708b. The cache layer stores copies of records from the first memory store 708a and the second memory store 708b that have been accessed during the current communication session or that are predicted to be relevant. The cache layer can be implemented using an in-memory data store that provides lower access latency than the underlying persistent memory stores 708. When the avatar interaction platform retrieves a record, the avatar interaction platform can first query the cache layer. If the cache layer contains the requested record (a cache hit), the avatar interaction platform retrieves the record from the cache layer without querying the underlying memory stores 708. If the cache layer does not contain the requested record (a cache miss), the avatar interaction platform queries the underlying memory store 708 and stores a copy of the retrieved record in the cache layer for potential future access.

The avatar interaction platform can aggregate or otherwise unify data 710 from one or more memory stores 708 to generate a unified memory representation 712. The avatar interaction platform can generate a vector embedding for each record in the data 710 using an embedding model. A vector embedding refers to a numerical representation of a record encoded as a fixed-length array of floating-point values. The array encodes the semantic meaning of the record such that records with similar meaning are represented by arrays with similar numerical values. The embedding model refers to a neural network that has been trained to produce vector embeddings that capture semantic relationships between words and phrases. The embedding model receives an input (e.g., the content of a user input record or an avatar response record) and processes the input through multiple layers of the neural network. Each layer applies a transformation to the data received from the preceding layer, where the transformation is defined by parameter weights learned during training. The final layer outputs the vector embedding as the numerical representation of the input.

The avatar interaction platform can index the vector embeddings into a common vector space accessible by the artificial intelligence avatar. The common vector space can be implemented as a vector index data structure that stores vector embeddings by organizing vector embeddings using spatial partitioning operations (e.g., hierarchical navigable small world graphs or inverted file indexes) to enable the avatar interaction platform to identify vector embeddings located near a query vector without comparing the query vector against every stored embedding. The indexing operation inserts each vector embedding into the vector index data structure and/or with a reference to the source record from which the embedding was generated. The reference enables the avatar interaction platform to retrieve the full record content after identifying one or more embeddings through similarity search. The unified memory representation 712 refers to the populated vector index data structure that includes the indexed vector embeddings generated from records across the memory stores 708.

In some implementations, the avatar interaction platform aggregates data 710 from one or more memory stores 708 to generate a unified memory representation 712 using different approaches that do not rely on vector embeddings. For example, the avatar interaction platform aggregates the data 710 by concatenating records from each memory store 708 into a single data structure that preserves the source identifier and timestamp associated with each record. The concatenated data structure organizes records in chronological order based on timestamps, which enables the avatar interaction platform to traverse the unified memory representation 712 sequentially when retrieving context for response generation.

In some implementations, the avatar interaction platform aggregates the data 710 by constructing a knowledge graph that represents entities mentioned in the records as nodes and relationships between entities as edges. Each node in the knowledge graph corresponds to a person or object or concept referenced in one or more records, and each edge represents a relationship (e.g., “discussed with” or “expressed preference for” or “inquired about”) that connects two entities. The knowledge graph enables the avatar interaction platform to retrieve context by traversing edges from entities mentioned in the current user input to related entities and their associated records.

The avatar interaction platform can aggregate the data 710 by indexing records using keyword-based indexing techniques that map terms appearing in the records to the records containing those terms. The keyword-based index enables the avatar interaction platform to retrieve records that contain specific terms mentioned in the user input. In some implementations, the avatar interaction platform can aggregate the data 710 by maintaining a structured summary representation that condenses information from multiple records into a compact format. The structured summary representation extracts information such as user preferences and topics from each record and organizes the extracted information into predefined categories, which enables the avatar interaction platform to retrieve relevant context by querying specific categories rather than searching across all stored records.

In some implementations, the avatar interaction platform can generate, using the unified memory representation 712, a user-specific input 714. The avatar interaction platform can apply one or more weighting operations to portions of the unified memory representation 712 to generate the user-specific input 714. Each portion of the unified memory representation 712 corresponds to a vector embedding and its associated source record. The weighting operations can assign a weight value to each portion based on a timestamp associated with that portion. The timestamp can be extracted from the metadata fields of the source record and indicate when the record was created or last modified. The weighting operations determine the weight value by evaluating a weighting function that uses the timestamp as input to produce a numerical weight as output. The weighting function assigns higher weight values to records associated with more recent timestamps relative to records associated with older timestamps. For example, the weighting function can determine the weight value as an inverse function of the elapsed time between the timestamp and the current time, such that a record created one hour ago receives a higher weight than a record created one week ago.

In some implementations, the weighting operations apply a decay function that reduces the weight value assigned to each record as a function of elapsed time from the timestamp associated with the record. The decay function can be implemented as an exponential decay function that multiplies an initial weight value by a decay factor raised to a power proportional to the elapsed time. A smaller decay factor causes weight values to decrease more rapidly, while a larger decay factor causes weight values to decrease more gradually. The user-specific input 714 refers to the collection of vector embeddings and associated source records augmented with computed weight values that reflect both semantic relevance to the current query and temporal recency of each record.

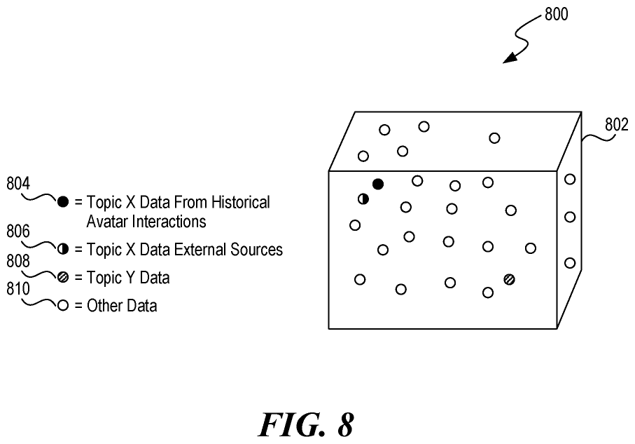

FIG. 8 shows an illustration of an example environment 800 of a latent space 802 used by an avatar interaction platform to synchronize memory from multiple sources, in accordance with some implementations of the present technology. The environment 800 can be implemented using components of example computer system 1000 illustrated and described in more detail with reference to FIG. 10. Likewise, implementations of example environment 800 can include different and/or additional components or can be connected in different ways. In some implementations, example environment 800 can be used to synchronize memory from multiple sources to create a user-specific input, such as user-specific input 714 described with reference to FIG. 7.

The latent space 802 can be used to represent memory from different sources. The latent space 802 refers to a multi-dimensional vector space in which semantically related data is mapped to proximate positions such that records with similar meaning are represented by vectors that are closer together than records with dissimilar meaning. The latent space 802 can be constructed by defining a coordinate system with a fixed number of dimensions, where each dimension corresponds to a learned feature that captures some aspect of semantic meaning. Each record from the memory stores 708 (as described in FIG. 7) can be transformed into a point in the latent space 802 by generating a vector embedding that assigns a numerical value to each dimension. The numerical values can be determined by an embedding model (as described in FIG. 7) that processes the content of the record through a neural network trained to position semantically similar content at nearby coordinates. The latent space 802 enables the avatar interaction platform to compare records from different memory sources using geometric distance or other similarity metrics rather than exact matching. For example, records that discuss similar concepts or address similar user needs are positioned in the same region of the latent space 802 even if the records use different vocabulary or phrasing to express those concepts.

In the environment 800, a first vector representation 804 can represent topic X data from historical avatar interactions. The first vector representation 804 refers to a numerical encoding of records generated by an AI avatar during prior communication sessions (such as the historical avatar session data 710a described in FIG. 7), where the records pertain to a particular subject matter (e.g., topic X). The first vector representation 804 can be computed by extracting the text content from a record in the historical avatar session data 710a and processing the text through the embedding model to produce a fixed-length array. Each floating-point value in the array corresponds to one dimension of the latent space 802 and encodes the degree to which the record exhibits the semantic feature associated with that dimension. The first vector representation 804 is then inserted into the latent space 802 at the coordinates specified by the floating-point values, along with a reference pointer that links the vector representation back to the source record in the first memory store 608a.

A second vector representation 806 can represent topic X data from external sources. The second vector representation 806 refers to a numerical encoding of records generated by an external source (such as the system-accessible repository data 710b described in FIG. 7), where the records pertain to the same subject matter as the first vector representation 804 (e.g., topic X). The external source can include notes documented by a representative during direct engagements with a user that occurred independently of the AI avatar, and/or interaction logs captured by automated systems from communication channels other than the avatar application 706. The second vector representation 806 can be computed using the same embedding model and the same dimensional structure as the first vector representation 804, which ensures that records from different sources are mapped into a common coordinate system.

A third vector representation 808 can represent topic Y data. The third vector representation 808 refers to a numerical encoding of records pertaining to a different subject matter (e.g., topic Y) than the first vector representation 804 and the second vector representation 806. Topic Y represents a distinct category of information that addresses different user needs or discusses different concepts than topic X. The third vector representation 808 can be computed using the same embedding process as the first vector representation 804 and the second vector representation 806, but the resulting coordinates can differ because the semantic content of the underlying record differs.

A fourth vector representation 810 can represent other data. The fourth vector representation 810 refers to a numerical encoding of records pertaining to subject matter distinct from both topic X and topic Y. The fourth vector representation 810 can represent records that address miscellaneous user needs or contain general information that does not fall within the defined topic categories.

Since both the first vector representation 804 and the second vector representation 806 are related to topic X, the first vector representation 804 and the second vector representation 806 are positioned closer to each other in the latent space 802 than to the third vector representation 808 because the third vector representation 808 is directed to topic Y. When the embedding model processes a record about topic X from the historical avatar session data 610a and a record about topic X from the historical external session data 610b, the model identifies shared semantic features (such as references to the same concepts or use of related terminology) and assigns similar values to the dimensions that encode those features. The resulting vector representations occupy nearby positions in the latent space 802 because their coordinate values are similar across one or more dimensions. In contrast, the third vector representation 808 occupies a more distant position because the underlying record discusses topic Y, which is associated with different concepts and terminology that activate different dimensions of the latent space 802.

The avatar interaction platform can perform a similarity search within the latent space 802 by generating a query vector from user input data and identifying vector representations that satisfy a similarity threshold relative to the query vector. The query vector can be computed by processing the user input data 702 (as described in FIG. 7) through the same embedding model used to generate the stored vector representations. The similarity search determines a distance metric between the query vector and each stored vector representation in the latent space 802. The distance metric quantifies how far apart two vectors are positioned in the multi-dimensional space. For example, a distance metric such as cosine similarity produces a value between negative one and positive one, where values closer to positive one indicate that the vectors point in similar directions (and thus represent semantically similar content) and values closer to negative one indicate that the vectors point in opposite directions (and thus represent semantically dissimilar content). The avatar interaction platform identifies vector representations that satisfy the similarity threshold by comparing the computed distance metric against a predefined threshold value (e.g., a cosine similarity of 0.8 or higher). Vector representations with distance metrics that exceed the threshold can be considered semantically relevant to the user input and can be retrieved for inclusion in the context provided to the avatar response generation engine 716 (as described in FIG. 7).

The similarity search enables the avatar interaction platform to retrieve records from different memory sources (such as the historical avatar session data 710a and the system-accessible repository data 710b) that are semantically related to the user input data regardless of the originating source of those records. In some implementations, the avatar interaction platform applies a re-ranking operation to the vector representations identified by the similarity search. The re-ranking operation adjusts the ordering of retrieved vector representations based on additional factors beyond semantic similarity. For example, the re-ranking operation can incorporate the weight values from the user-specific input 714 (as described in FIG. 7) to promote more recent records over older records that have similar semantic relevance. The re-ranking operation can incorporate source preference factors that promote records from certain memory sources (such as the session context data 710c) over records from other memory sources when the user input indicates a need for information about the current conversation.

In some implementations, the avatar interaction platform performs an approximate nearest neighbor search to reduce computational overhead when the latent space 802 contains a large number of vector representations. The approximate nearest neighbor search uses indexing structures (such as hierarchical partitions of the vector space) to identify candidate vector representations that are likely to be among the most similar to the query vector without computing exact distances to every stored vector. The approximate nearest neighbor search enables the avatar interaction platform to maintain low response latency even as the volume of stored records grows.

### Example Implementation of the Models of the Avatar Interaction Platform

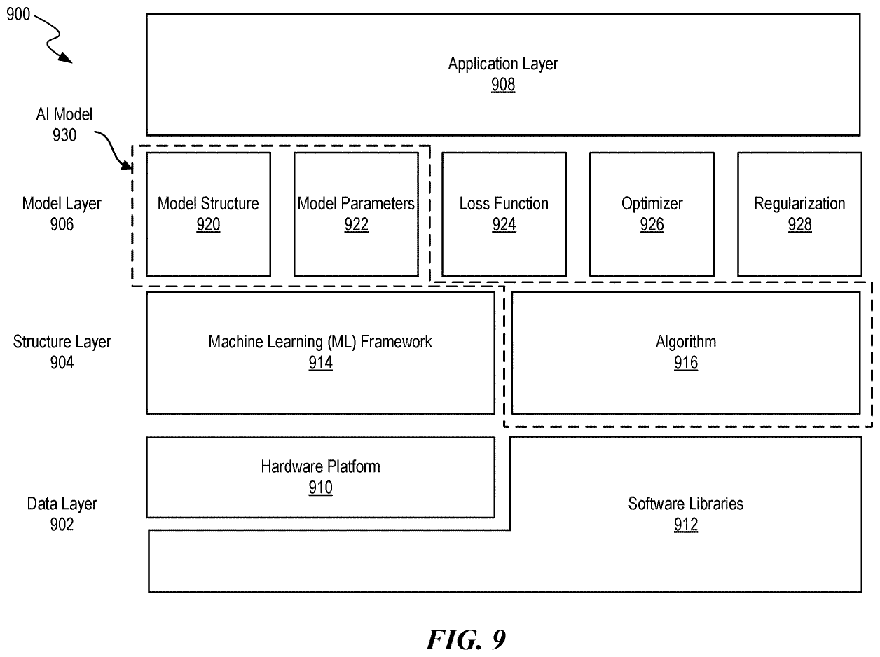

FIG. 9 illustrates a layered architecture of an AI system 900 that can implement the ML models of the avatar interaction platform of FIG. 9, in accordance with some implementations of the present technology. Example ML models can include the models executed by the avatar interaction platform, such as the agents 610 and/or the generative AI model 618 in FIG. 6. Accordingly, the agents 610 and/or the generative AI model 618 in FIG. 6 can include one or more components of the AI system 900.

As shown, the AI system 900 can include a set of layers, which conceptually organize elements within an example network topology for the AI system's architecture to implement a particular AI model (e.g., the AI model 930). Generally, an AI model is a computer-executable program implemented by the AI system 900 that analyses data to make predictions. Information can pass through each layer of the AI system 900 to generate outputs for the AI model. The layers can include a data layer 902, a structure layer 904, a model layer 906, and an application layer 908. The algorithm 916 of the structure layer 904 and the model structure 920 and model parameters 922 of the model layer 906 together form an example AI model. The optimizer 926, loss function engine 924, and regularization engine 928 work to refine and optimize the AI model, and the data layer 902 provides resources and support for application of the AI model by the application layer 908.

The data layer 902 acts as the foundation of the AI system 900 by preparing data for the AI model. As shown, the data layer 902 can include two sub-layers: a hardware platform 910 and one or more software libraries 912. The hardware platform 910 can be designed to perform operations for the AI model and include computing resources for storage, memory, logic and networking, such as the resources described in relation to FIGS. 10 and 11. The hardware platform 910 can process amounts of data using one or more servers. The servers can perform backend operations such as matrix calculations, parallel calculations, machine learning (ML) training, and the like. Examples of servers used by the hardware platform 910 include CPUs and GPUs. CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 910 can include computing resources (e.g., servers, memory, etc.) offered by a cloud services provider. The hardware platform 910 can also include computer memory for storing data about the AI model, application of the AI model, and training data for the AI model. The computer memory can be a form of random-access memory (RAM), such as dynamic RAM, static RAM, and non-volatile RAM.

The software libraries 912 can be thought of suites of data and programming code, including executables, used to control the computing resources of the hardware platform 910. The programming code can include low-level primitives (e.g., fundamental language elements) that form the foundation of one or more low-level programming languages, such that servers of the hardware platform 910 can use the low-level primitives to carry out specific operations. The low-level programming languages do not require much, if any, abstraction from a computing resource's instruction set architecture, enabling them to run quickly with a small memory footprint. Examples of software libraries 912 that can be included in the AI system 900 include INTEL Math Kernel Library, NVIDIA cuDNN, EIGEN, and OpenBLAS.

The structure layer 904 can include an ML framework 914 and an algorithm 916. The ML framework 914 can be thought of as an interface, library, or tool that enables users to build and deploy the AI model. The ML framework 914 can include an open-source library, an API, a gradient-boosting library, an ensemble method, and/or a deep learning toolkit that work with the layers of the AI system facilitate development of the AI model. For example, the ML framework 914 can distribute processes for application or training of the AI model across multiple resources in the hardware platform 910. The ML framework 914 can also include a set of pre-built components that have the functionality to implement and train the AI model and enable users to use pre-built functions and classes to construct and train the AI model. Thus, the ML framework 914 can be used to facilitate data engineering, development, hyperparameter tuning, testing, and training for the AI model. Examples of ML frameworks 914 that can be used in the AI system 900 include TENSORFLOW, PYTORCH, SCIKIT-LEARN, KERAS, LightGBM, RANDOM FOREST, and AMAZON WEB SERVICES.

The algorithm 916 can be an organized set of computer-executable operations used to generate output data from a set of input data and can be described using pseudocode. The algorithm 916 can include complex code that enables the computing resources to learn from new input data and create new/modified outputs based on what was learned. In some implementations, the algorithm 916 can build the AI model through being trained while running computing resources of the hardware platform 910. This training enables the algorithm 916 to make predictions or decisions without being explicitly programmed to do so. Once trained, the algorithm 916 can run at the computing resources as part of the AI model to make predictions or decisions, improve computing resource performance, or perform tasks. The algorithm 916 can be trained using supervised learning, unsupervised learning, semi-supervised learning, and/or reinforcement learning.

Using supervised learning, the algorithm 916 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of audio data in FIG. 6) from various source computing systems described in relation to FIG. 9. Furthermore, training data can include pre-processed data generated by various engines of the avatar interaction platform described in relation to FIG. 9. The user may label the training data based on one or more classes and trains the AI model by inputting the training data to the algorithm 916. The algorithm determines how to label the new data based on the labeled training data. The user can facilitate collection, labeling, and/or input via the ML framework 914. In some instances, the user may convert the training data to a set of feature vectors for input to the algorithm 916. Once trained, the user can test the algorithm 916 on new data to determine if the algorithm 916 is predicting accurate labels for the new data. For example, the user can use cross-validation methods to test the accuracy of the algorithm 916 and retrain the algorithm 916 on new training data if the results of the cross-validation are below an accuracy threshold.

Supervised learning can include classification and/or regression. Classification techniques include teaching the algorithm 916 to identify a category of new observations based on training data and are used when input data for the algorithm 916 is discrete. Said differently, when learning through classification techniques, the algorithm 916 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 916 can categorize new data by analyzing the new data for features that map to the categories. Examples of classification techniques include boosting, decision tree learning, genetic programming, learning vector quantization, KNN algorithm, and statistical classification.

Regression techniques include estimating relationships between independent and dependent variables and are used when input data to the algorithm 916 is continuous. Regression techniques can be used to train the algorithm 916 to predict or forecast relationships between variables. To train the algorithm 916 using regression techniques, a user can select a regression method for estimating the parameters of the model. The user collects and labels training data that is input to the algorithm 916 such that the algorithm 916 is trained to understand the relationship between data features and the dependent variable(s). Once trained, the algorithm 916 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine learning based pre-processing operations.

Under unsupervised learning, the algorithm 916 learns patterns from unlabeled training data. In particular, the algorithm 916 is trained to learn hidden patterns and insights of input data, which can be used for data exploration or for generating new data. Here, the algorithm 916 does not have a predefined output, unlike the labels output when the algorithm 916 is trained using supervised learning. Said another way, unsupervised learning is used to train the algorithm 916 to find an underlying structure of a set of data, group the data according to similarities, and represent that set of data in a compressed format. The avatar interaction platform can use unsupervised learning to identify patterns in claim history (e.g., to identify particular event sequences) and so forth. In some implementations, performance of the avatar interaction platform that can use unsupervised learning is improved because the incoming memories (e.g., audio data in FIG. 6) is pre-processed and reduced, based on the relevant triggers, as described herein.

A few techniques can be used in unsupervised learning: clustering, anomaly detection, and techniques for learning latent variable models. Clustering techniques include grouping data into different clusters that include similar data, such that other clusters contain dissimilar data. For example, during clustering, data with possible similarities remains in a group that has less or no similarities to another group. Examples of clustering techniques density-based methods, hierarchical based methods, partitioning methods, and grid-based methods. In one example, the algorithm 916 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 916 may be trained to be an Isolation Forest, local outlier factor (LOF) algorithm, or KNN algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that may be used by the algorithm 916 include factor analysis, item response theory, latent profile analysis, and latent class analysis.

The model layer 906 implements the AI model using data from the data layer and the algorithm 916 and ML framework 914 from the structure layer 904, thus enabling decision-making capabilities of the AI system 900. The model layer 906 includes a model structure 920, model parameters 922, a loss function engine 924, an optimizer 926, and a regularization engine 928.

The model structure 920 describes the architecture of the AI model of the AI system 900. The model structure 920 defines the complexity of the pattern/relationship that the AI model expresses. Examples of structures that can be used as the model structure 920 include decision trees, support vector machines, regression analyses, Bayesian networks, Gaussian processes, genetic algorithms, and artificial neural networks (or, simply, neural networks). The model structure 920 can include a number of structure layers, a number of nodes (or neurons) at each structure layer, and activation functions of each node. Each node's activation function defines how a node converts data received to data output. The structure layers may include an input layer of nodes that receive input data, an output layer of nodes that produce output data. The model structure 920 may include one or more hidden layers of nodes between the input and output layers. The model structure 920 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 922 represent the relationships learned during training and can be used to make predictions and decisions based on input data. The model parameters 922 can weigh and bias the nodes and connections of the model structure 920. For instance, when the model structure 920 is a neural network, the model parameters 922 can weight and bias the nodes in each layer of the neural networks, such that the weights determine the strength of the nodes and the biases determine the thresholds for the activation functions of each node. The model parameters 922, in conjunction with the activation functions of the nodes, determine how input data is transformed into desired outputs. The model parameters 922 can be determined and/or altered during training of the algorithm 916.

The loss function engine 924 can determine a loss function, which is a metric used to evaluate the AI model's performance during training. For instance, the loss function engine 924 can measure the difference between a predicted output of the AI model and the actual output of the AI model and is used to guide optimization of the AI model during training to minimize the loss function. The loss function may be presented via the ML framework 914, such that a user can determine whether to retrain or otherwise alter the algorithm 916 if the loss function is over a threshold. In some instances, the algorithm 916 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 926 adjusts the model parameters 922 to minimize the loss function during training of the algorithm 916. In other words, the optimizer 926 uses the loss function generated by the loss function engine 924 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 926 used may be determined based on the type of model structure 920 and the size of data and the computing resources available in the data layer 902.

The regularization engine 928 executes regularization operations. Regularization is a technique that prevents over-and under-fitting of the AI model. Overfitting occurs when the algorithm 916 is overly complex and too adapted to the training data, which can result in poor performance of the AI model. Underfitting occurs when the algorithm 916 is unable to recognize even basic patterns from the training data such that it cannot perform well on training data or on validation data. The optimizer 926 can apply one or more regularization techniques to fit the algorithm 916 to the training data properly, which helps constrain the resulting AI model and improves its ability for generalized application. Examples of regularization techniques include lasso (L1) regularization, ridge (L2) regularization, and elastic (L1 and L2 regularization).

The application layer 908 describes how the AI system 900 is used to solve problems or perform tasks. In an example implementation, the application layer 908 can include a front-end user interface of the avatar interaction platform.

### Example Computing Environment of the Avatar Interaction Platform

FIG. 10 is a block diagram showing some of the components typically incorporated in at least some of the computer systems 1000 and other devices on which the disclosed system operates in accordance with some implementations of the present technology. As shown, an example computer system 1000 can include: one or more processors 1002, main memory 1006, non-volatile memory 1010, a network interface device 1012, video display device 1018, an input/output device 1020, a control device 1022 (e.g., keyboard and pointing device), a drive unit 1024 that includes a machine-readable medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computer system 1000 can share a similar architecture to that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 1000. In some implementations, the computer system 1000 can be an embedded computer system, a system-on-chip (SOC), a single-board computer system (SBC) or a distributed system such as a mesh of computer systems or include one or more cloud components in one or more networks. Where appropriate, one or more computer systems 1000 can perform operations in real time, near real time, or in batch mode.

The network interface device 1012 enables the computer system 1000 to exchange data in a network 1014 with an entity that is external to the computing system 1000 through any communication protocol supported by the computer system 1000 and the external entity. Examples of the network interface device 1012 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable (storage) medium 1026 can include any medium that is capable of storing, encoding, or carrying a set of instructions for execution by the computer system 1000. The machine-readable medium 1026 can be non-transitory or include a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically include one or more instructions (e.g., instructions 1008, 1028) set at various times in various memory and storage devices in computing device(s). When read and executed by the processor 1002, the instruction(s) cause the computer system 1000 to perform operations to execute elements involving the various aspects of the disclosure.

FIG. 11 is a system diagram illustrating an example of a computing environment in which the disclosed system operates in some implementations. In some implementations, environment 1100 includes one or more client computing devices 1105A-D, examples of which can host the avatar interaction platform of FIG. 6. Client computing devices 1105 operate in a networked environment using logical connections through network 1130 to one or more remote computers, such as a server computing device.

In some implementations, server computing device 1110 is an edge server which receives client requests and coordinates fulfillment of those requests through other servers, such as servers 1120A-C. In some implementations, server computing devices 1110 and 1120 include computing systems, such as the avatar interaction platform of FIG. 6. Though each server computing device 1110 and 1120 is displayed logically as a single server, server computing devices can each be a distributed computing environment encompassing multiple computing devices located at the same or at geographically disparate physical locations. In some implementations, each server computing device 1120 corresponds to a group of servers.

Client computing devices 1105 and server computing devices 1110 and 1120 can each act as a server or client to other server or client devices. In some implementations, servers (1210, 1120A-C) connect to a corresponding database (1215, 1125A-C). As discussed above, each server computing device 1120 can correspond to a group of servers, and each of these servers can share a database or can have its own database. Databases 1115 and 1125 warehouse (e.g., store) information such as claims data, email data, call transcripts, call logs, policy data and so on. Though databases 1115 and 1125 are displayed logically as single units, databases 1115 and 1125 can each be a distributed computing environment encompassing multiple computing devices, can be located within their corresponding server, or can be located at the same or at geographically disparate physical locations.

Network 1130 can be a local area network (LAN) or a wide area network (WAN), but can also be other wired or wireless networks. In some implementations, network 1130 is the Internet or some other public or private network. Client computing devices 1105 are connected to network 1130 through a network interface, such as by wired or wireless communication. While the connections between server computing device 1110 and server computing devices 1120 are shown as separate connections, these connections can be any kind of local, wide area, wired, or wireless network, including network 1130 or a separate public or private network.

### Conclusion

Unless the context clearly requires otherwise, throughout the description and the claims, the words “include,” “including,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having operations, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right after filing this application to pursue such additional claim forms, either in this application or in a continuing application.

From the foregoing, it will be appreciated that specific implementations of the invention have been described herein for purposes of illustration, but that various modifications can be made without deviating from the scope of the invention. Accordingly, the invention is not limited except as by the appended claims.

We claim:

1. A system for implementing a persistent memory-based architecture for avatar-based applications, the system comprising:
one or more processors; and
one or more non-transitory machine-readable media comprising instructions that when executed by the one or more processors cause operations comprising:
accessing a briefing data structure that aggregates observed interaction data between a user and an artificial intelligence agent across a plurality of interaction sessions,
wherein the observed interaction data is sequentially aggregated within the briefing data structure, and
wherein the briefing data structure is stored in a persistent memory accessible to an avatar interface configured to host the artificial intelligence agent;
in response to receiving additional interaction data via the avatar interface, linking one or more portions of the additional interaction data to the briefing data structure using a user identifier associated with the user;
constructing a user-specific input by combining (a) the briefing data structure, (b) the one or more portions of the additional interaction data, and (c) one or more of: a predicted state output generated using an artificial intelligence model using the observed interaction data from the briefing data structure or a dataset retrieved from one or more data repositories;
transmitting the user-specific input into one or more input layers of the artificial intelligence agent to generate a user-specific output responsive to the user-specific input; and
updating the briefing data structure to include a representation of the user-specific output in the briefing data structure.

2. The system of claim 1, wherein the instructions for generating the user-specific output further cause actions comprising:
querying a knowledge graph of the persistent memory by traversing one or more relational nodes of the knowledge graph to identify a subset of the briefing data structure corresponding to the additional interaction data;
identifying a correspondence between the additional interaction data and the subset of the briefing data structure; and
based on the correspondence meeting a similarity threshold, generating, using the artificial intelligence model, one or more user recommendations based on the subset of the briefing data structure, the one or more portions of the additional interaction data, and one or more of the predicted state output or the dataset.

3. The system of claim 2, wherein the instructions for generating the one or more user recommendations further cause actions comprising:
providing the subset of the briefing data structure, the one or more portions of the additional interaction data, and one or more of the predicted state output or the dataset as inputs to the artificial intelligence model; and
generating, using the artificial intelligence model, the user-specific output, wherein the user-specific output is constrained by the one or more relational nodes of the knowledge graph, and wherein the user-specific output identifies one or more recommended actions based on the subset of the briefing data structure, the one or more portions of the additional interaction data, and one or more of the predicted state output or the dataset as inputs to the artificial intelligence model.

4. The system of claim 1, wherein the dataset comprises one or more of: a peer information set or a historic dataset.

5. The system of claim 4, wherein the instructions further cause actions comprising:
determining for the user using the briefing data structure as input into a machine learning model, an entity cluster within a plurality of entity clusters, wherein the machine learning model has been trained to classify the user into the entity cluster of the plurality of entity clusters;
identifying, using the machine learning model, one or more peer entities associated with the entity cluster;
generating, for the entity cluster, an item characteristic dataset based on the one or more peer entities, wherein the item characteristic dataset includes one or more of performance data, probability data, or outcome data; and
determining, for the entity cluster based on the item characteristic dataset, a plurality of items for the peer information set.

6. The system of claim 4, wherein the instructions further cause actions comprising:
receiving an indication of the one or more data repositories;
one or more of:
using a large language model to generate a deterministic search query based on the one or more portions of the additional interaction data; or
retrieving the deterministic search query from a predetermined set of search queries based on the one or more portions of the additional interaction data; and
retrieving the historic dataset using the deterministic search query.

7. The system of claim 4, wherein the instructions further cause actions comprising:
generating a vector embedding for the one or more portions of the additional interaction data; and
querying one or more external resources using the vector embedding to retrieve the historic dataset.

8. The system of claim 1, wherein generating the predicted state output using the artificial intelligence model further comprises:
selecting a dataset from a plurality of historic datasets based on similarities between state characteristics of the dataset and one or more present states of time-series data included in the briefing data structure, wherein the dataset comprises rate-of-change data over a first time period;
detecting a rate-of-change event in the dataset by comparing the rate-of-change data to a threshold rate of change;
generating a normalized rate-of-change event by time-shifting the rate-of-change event from the first time period to correspond to a time during a second time period associated with the time-series data; and
generating the predicted state output by applying the normalized rate-of-change event to first rate-of-change data generated by the artificial intelligence model for the second time period.

9. At least one non-transitory, computer-readable medium storing instructions, which, when executed by at least one data processor of a system, cause the system to:
access a briefing data structure that aggregates one or more of: observed interaction data between a user and an artificial intelligence agent across a plurality of interaction sessions or user time-series data,
wherein the briefing data structure is stored in a persistent memory accessible to an avatar interface configured to host the artificial intelligence agent;
in response to receiving additional interaction data, link one or more portions of the additional interaction data to the briefing data structure;
construct a user-specific input by combining (a) the briefing data structure, (b) the one or more portions of the additional interaction data, and (c) one or more of:
a predicted state output generated using an artificial intelligence model using the observed interaction data from the briefing data structure or a dataset retrieved from one or more data repositories;
transmit the user-specific input into one or more input layers of the artificial intelligence agent to generate a user-specific output responsive to the user-specific input; and
update the briefing data structure to include a representation of the user-specific output in the briefing data structure.

10. The at least one non-transitory, computer-readable medium of claim 9, wherein the instructions for generating the user-specific output further cause actions comprising:
querying a knowledge graph of the persistent memory by traversing one or more relational nodes of the knowledge graph to identify a subset of the briefing data structure corresponding to the additional interaction data;
identifying a correspondence between the additional interaction data and the subset of the briefing data structure; and
based on the correspondence meeting a similarity threshold, generating, using the artificial intelligence model, one or more user recommendations based on the subset of the briefing data structure, the one or more portions of the additional interaction data, and one or more of the predicted state output or the dataset.

11. The at least one non-transitory, computer-readable medium of claim 10, wherein the instructions for generating the one or more user recommendations further cause actions comprising:
providing the subset of the briefing data structure, the one or more portions of the additional interaction data, and one or more of the predicted state output or the dataset as inputs to the artificial intelligence model; and
generating, using the artificial intelligence model, the user-specific output, wherein the user-specific output is constrained by the one or more relational nodes of the knowledge graph, and wherein the user-specific output identifies one or more recommended actions based on the subset of the briefing data structure, the one or more portions of the additional interaction data, and one or more of the predicted state output or the dataset as inputs to the artificial intelligence model.

12. The at least one non-transitory, computer-readable medium of claim 9, wherein the dataset comprises one or more of: a peer information set or a historic dataset.

13. The at least one non-transitory, computer-readable medium of claim 12, wherein the instructions further cause actions comprising:
determining for the user using the briefing data structure as input into a machine learning model, an entity cluster within a plurality of entity clusters, wherein the machine learning model has been trained to classify the user into the entity cluster of the plurality of entity clusters;
identifying, using the machine learning model, one or more peer entities associated with the entity cluster;
generating, for the entity cluster, an item characteristic dataset based on the one or more peer entities, wherein the item characteristic dataset includes one or more of performance data, probability data, or outcome data; and
determining, for the entity cluster based on the item characteristic dataset, a plurality of items for the peer information set.

14. The at least one non-transitory, computer-readable medium of claim 12, wherein the instructions further cause actions comprising:
receiving an indication of the one or more data repositories;
one or more of:
using a large language model to generate a deterministic search query based on the one or more portions of the additional interaction data; or
retrieving the deterministic search query from a predetermined set of search queries based on the one or more portions of the additional interaction data; and
retrieving the historic dataset using the deterministic search query.

15. The at least one non-transitory, computer-readable medium of claim 12, wherein the instructions further cause actions comprising:
generating a vector embedding for the one or more portions of the additional interaction data; and
querying one or more external resources using the vector embedding to retrieve the historic dataset.

16. The at least one non-transitory, computer-readable medium of claim 9, wherein
generating the predicted state output using the artificial intelligence model further comprises:
selecting a dataset from a plurality of historic datasets based on similarities between state characteristics of the dataset and one or more present states of time-series data included in the briefing data structure, wherein the dataset comprises rate-of-change data over a first time period;
detecting a rate-of-change event in the dataset by comparing the rate-of-change data to a threshold rate of change;
generating a normalized rate-of-change event by time-shifting the rate-of-change event from the first time period to correspond to a time during a second time period associated with the time-series data; and
generating the predicted state output by applying the normalized rate-of-change event to first rate-of-change data generated by the artificial intelligence model for the second time period.

17. A computer-implemented method comprising:
accessing, from a persistent memory, a briefing data structure that aggregates observed interaction data between a user and an artificial intelligence agent across a plurality of interaction sessions;
in response to receiving additional interaction data, identifying one or more portions of the additional interaction data corresponding to the briefing data structure;
constructing a user-specific input comprising (a) the briefing data structure, (b) the one or more portions of the additional interaction data, and (c) one or more of:
a predicted state output generated by an artificial intelligence model or a dataset retrieved from one or more data repositories; and
providing the user-specific input to one or more input layers of the artificial intelligence agent to generate a user-specific output.

18. The computer-implemented method of claim 17, wherein generating the user-specific output further comprises:
querying a knowledge graph of the persistent memory by traversing one or more relational nodes of the knowledge graph to identify a subset of the briefing data structure corresponding to the additional interaction data;
identifying a correspondence between the additional interaction data and the subset of the briefing data structure; and
based on the correspondence meeting a similarity threshold, generating, using the artificial intelligence model, one or more user recommendations based on the subset of the briefing data structure, the one or more portions of the additional interaction data, and one or more of the predicted state output or the dataset.

19. The computer-implemented method of claim 18, wherein generating the one or more user recommendations further comprises:
providing the subset of the briefing data structure, the one or more portions of the additional interaction data, and one or more of the predicted state output or the dataset as inputs to the artificial intelligence model; and
generating, using the artificial intelligence model, the user-specific output, wherein the user-specific output is constrained by the one or more relational nodes of the knowledge graph, and wherein the user-specific output identifies one or more recommended actions based on the subset of the briefing data structure, the one or more portions of the additional interaction data, and one or more of the predicted state output or the dataset as inputs to the artificial intelligence model.

20. The computer-implemented method of claim 17, wherein the dataset comprises one or more of: a peer information set or a historic dataset.
